(19) United States
(12) Patent Application Publication
(10) Pub. No.: US 2022/0058944 A1
(43) Pub. Date: Feb. 24, 2022

(54) COMPUTER-BASED METHOD AND SYSTEM FOR TRAFFIC CONGESTION FORECASTING

(71) Applicant: QUANTELA INC, Milpitas, CA (US)

(72) Inventors: Sanjiv Kumar Jha, Bangalore (IN); Rohit Nair, Nagpur (IN)

(21) Appl. No.: 17/001,093

(22) Filed: Aug. 24, 2020

(51) Int. Cl. G08G 1/01; G06T 11/00; G06K 9/00; H04N 7/18; G06N 3/04

(52) U.S. Cl. CPC G08G 1/0129; G08G 1/0133; G08G 1/0141; G06N 3/04; G06K 9/00785; H04N 7/181; G06T 11/00

(57) ABSTRACT

A computer-implemented method and system for traffic congestion forecasting are disclosed herein. The computer-implemented method executed by a traffic congestion forecasting system is used for congestion bottleneck identification and root cause analysis thereof. The computer-implemented method comprises receiving one or more of real-time geographical & temporal parameters, real-time visual indicators and historical dataset associated with each of a plurality of zones, forecasts traffic congestion level at one or more of the plurality of zones, visually overlaying the forecasted traffic congestion level at the one or more zones on a map and displaying the map on one or more user devices with overlaid traffic congestion level.

### FIELD OF THE INVENTION

Embodiments described herein in general, concern a computer-based method and system for forecasting traffic congestion. More particularly, the embodiments concern a computer-implemented method and system for congestion bottleneck identification and root cause analysis thereof.

### BACKGROUND OF THE INVENTION

Unless otherwise indicated herein, the approaches described in this section are not prior art to the claims in this application and are not admitted to be prior art by inclusion in this section.

With the increase in number of people living in cities and urban areas along with ever-growing population of vehicles, traffic management has become a serious issue for individuals across the globe. The surged traffic problems have led to a direct impact on productivity, environment, fuel consumption, health, and quality of life.

Traditionally, the traffic management systems utilized data gathered from sources such as Global Positioning Systems (GPS) mounted on the vehicles to predict traffic levels. However, such systems lacked accuracy as they did not utilize other factors such as geographical parameters associated with an area, current road accidents etc. to predict the traffic levels. Thereby making the overall system inefficient.

To overcome the above said disadvantages, the traffic levels prediction models were developed with integrated real-time data associated with an area along with different geological aspects to predict the traffic levels in real-time. These conventional computer-based systems for predicting traffic level depend largely on real-time acquired data and are suitable to predict short duration traffic levels. Also, such computer-based systems lack identification of the hotspots and the reasons associated with the formation of such hotspots. Further, such systems do not predict traffic levels in advance for a longer duration so that the traffic administration can manage the traffic well in advance based on the predicted traffic levels.

Hence, it is apparent that a need exists for an automated computer-based method and system for traffic congestion forecasting, congestion bottleneck identification and root cause analysis thereof which utilizes both real-time and historical data associated with the traffic bottleneck and root cause thereof to accurately predict traffic congestion levels for short and long term duration.

### SUMMARY OF THE INVENTION

According to an embodiment, a computer-implemented method implemented by traffic congestion forecasting system for congestion bottleneck identification and root cause analysis thereof is described. The computer-implemented method comprises receiving one or more of real-time geographical & temporal parameters, real-time visual indicators associated with each of a plurality of zones. The computer-implemented method further comprises receiving a historical dataset associated with each of the plurality of zones. The historical dataset comprises one or more of past geographical & temporal parameters and effects thereof on past traffic congestion level, past visual indicators and effects thereof on past traffic congestion level, past bottleneck and past traffic congestion levels with associated root-cause thereof. The computer-implemented method forecasts traffic congestion level at one or more of the plurality of zones by processing one or more of the received real-time geographical parameters, the real-time visual indicators, and the historical dataset associated thereof. The forecasted traffic congestion level is visually overlaid at the one or more zones on a map and the computer-implemented method further facilitates display of the map on one or more user devices with overlaid traffic congestion level.

According to an example, the one or more real-time geographical & temporal parameters is received from a Geographic Information System (GIS) and the one or more real-time visual indicators is received from a video source.

According to an example, the geographical & temporal parameters comprises one or more of weather conditions, a real-time and historical geographic traffic pattern, a road elevation information, traffic information received from GPS devices in proximity of the zones, latitude/longitude details of the zones, road width, a news forecast of the zones, a real-time geographic travel pattern, traffic congestion duration at the zones, potential traffic hotspots and location thereof, information related to potential traffic obstruction points in vicinity of the zones, and peak time associated with traffic obstruction hotspots.

According to an example, the visual indicators comprises one or more of a visual data-feed captured by cameras installed in vicinity of at least one of the plurality of zones, data feeds from traffic light cameras, visual feeds from dashcams, visual feeds indicating traffic movement, visual feed indicating pedestrian movement, visual feed indicating road obstacles, visual feed received one or more video sensors, visual feed indicating people density in an geographical area, visual feeds indicating road accident, visual feeds indicating construction, and visual feeds indicating congestion density.

According to an example, forecasting the traffic congestion level at one or more of the plurality of zones further comprises receiving location of the one or more zones from an operator of the user device for which the traffic congestion level is to be forecasted.

According to an example, forecasting the traffic congestion level at one or more of the plurality of zones further comprises receiving a desired time frame selected by an operator of the user device for which the traffic is to be forecasted and forecasting the traffic congestion level at one or more of the plurality of zones for the desired time frame.

According to an example, forecasting the traffic congestion level at the one or more of the plurality of zones further comprises determining one or more high traffic congestion zones by comparing the forecasted traffic congestion level with a threshold traffic congestion level.

According to an example, forecasting the traffic congestion level at the one or more of the plurality of zones further comprises determining traffic bottlenecks and root-cause thereof at the one or more high traffic congestion zones by analyzing the one or more of the received real-time geographical & temporal parameters, the real-time visual indicators, and the historical dataset associated with the one or more high traffic congestion zones.

According to an example, forecasting the traffic congestion level at the one or more of the plurality of zones further comprises determining one or more strategies to mitigate one or more of the traffic bottlenecks and the traffic congestion level at the one or more high traffic congestion zones and providing the determined strategies to an operator of the user device.

According to an example, determining one or more strategies to mitigate one or more of the traffic bottlenecks and the traffic congestion level further comprises generating one or more simulated strategies to mitigate one or more of the traffic bottlenecks and the traffic congestion level wherein the simulated strategies comprises at least one of a traffic light timing simulation and a divergence route simulation.

According to an example, forecasting the traffic congestion level comprises forecasting the traffic congestion level by using a feedforward neural network.

According to an example, the feedforward neural network comprises a ReLu activation and/or a Nesterov ADAM optimizer to generate the forecasted traffic congestion level.

According to another exemplary embodiment, a system for congestion bottleneck identification and root cause analysis thereof is described. The system comprises at least one processor and a memory that is coupled to the at least one processor, and the processor is configured to perform all or some steps of the method described above.

According to another exemplary embodiment, a non-transitory computer readable medium is described. The system comprises at least one processor and at least one computer readable memory coupled to the at least one processor, and the processor is configured to perform all or some steps of the method described above.

It is an object of the invention to provide a fully automated computer based method and system therefor for congestion bottleneck identification and root cause analysis thereof and to generate a forecasted traffic congestion level at one or more of the plurality of zones where a user does is presented with a visually overlaid forecasted traffic congestion level at the one or more zones on a map on one or more user devices. The object is to provide a fully automated computer based method and a system therefor to compare the forecasted traffic congestion level with a threshold traffic congestion level and determine traffic bottlenecks and root-cause thereof at the one or more high traffic congestion zones.

It is an object of the invention to provide a fully automated computer based method and system therefor for forecasting traffic congestion by quantitative assessment of one or more of the received real-time geographical & temporal parameters, the real-time visual indicators, and the historical dataset associated with the one or more one or more of the plurality of zones.

It is an object of the invention to provide a fully automated computer based method and system therefor for determining traffic bottlenecks and root-cause thereof at the one or more high traffic congestion zones by quantitative assessment of one or more of the received real-time geographical & temporal parameters, the real-time visual indicators, and the historical dataset associated with the one or more high traffic congestion zones.

It is an object of the invention to configure the traffic congestion forecasting system to retrieve historical data set associated with the one or more of the plurality of zones to forecast traffic congestion levels by analysing one or more of past geographical & temporal parameters and effects thereof on past traffic congestion level, past visual indicators and effects thereof on past traffic congestion level, past bottleneck and past traffic congestion levels with associated root-cause thereof.

It is an object of the invention to automatically provide one or more simulated strategies to mitigate one or more of the traffic bottlenecks and the traffic congestion level by the traffic congestion forecasting system wherein the one or more simulated strategies comprises at least one of a traffic light timing simulation and a divergence route simulation.

It is an object of the invention to automatically provide quantitative statistical measurements of traffic bottlenecks and the traffic congestion level by the traffic congestion forecasting system. The traffic congestion forecasting system is configured to receive the location of the one or more zones for which the traffic congestion level is to be forecasted from the user device of the operator. The traffic congestion forecasting system provides the statistical measurements of traffic bottlenecks and the traffic congestion level for the location of the one or more zones received from the operator by using the user device.

It is an object of the invention to automatically provide quantitative statistical measurements of traffic bottlenecks and the traffic congestion level by the traffic congestion forecasting system. The traffic congestion forecasting system is configured to receive the time frame for which the traffic bottlenecks and the traffic congestion level is to be forecasted from the user device of the operator. The traffic congestion forecasting system provides the statistical measurements of traffic bottlenecks and the traffic congestion level for the time frame received from the operator's user device.

It is an object of the invention to automatically provide quantitative absolute and relative change in the traffic congestion levels over a period of time by the traffic congestion forecasting system. Thereby facilitating the operator of the user device to monitor the traffic level both in advance and in real-time.

It is an object of the invention to automatically provide quantitative absolute and relative change in the traffic bottleneck and their root causes over a period of time by the traffic congestion forecasting system thereby facilitating the operator of the user device to monitor the traffic bottleneck both in advance and in real-time.

It is an object of the invention to provide statistical measurements of the traffic congestion level and the traffic bottlenecks by the traffic congestion forecasting system. The traffic congestion forecasting system can be suitably programmed to receive selection of one or more zones from the operator via the user device for which the traffic congestion level and the traffic bottlenecks is to be forecasted. The one or more zones can be city, a town, a road, a junction, a flyover, a railway track, or an airport wherein the traffic congestion level and the traffic bottlenecks can be provided for a specific road, sector, flyover, area, junction, point of interest (POI) associated with the operator of the user device selected one or more zones.

It is an object of the invention to provide the congestion bottleneck identification and root cause analysis thereof by the traffic congestion forecasting system. The traffic congestion forecasting system uses a feedforward network comprising a ReLu activation and/or a Nesterov ADAM optimizer to provide the congestion bottleneck identification and root cause analysis thereof.

The summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 schematically shows an exemplary environment 100 of a traffic congestion forecasting system 116 used for congestion bottleneck identification and root cause analysis thereof;

FIG. 2A schematically shows a block diagram of the traffic congestion forecasting system 116 for congestion bottleneck identification and root cause analysis thereof, according to an embodiment of the present invention;

FIG. 2B illustrates an exemplary workflow to predict congestion bottleneck identification and root cause analysis thereof, according to an embodiment of the present invention;

FIG. 3A is a flowchart 300 illustrating an exemplary workflow for forecasting a traffic congestion level at one or more of the plurality of zones 104 by a traffic congestion forecasting system, according to an embodiment of the present invention;

FIG. 3B illustrates an exemplary map 316 with visually overlaid traffic congestion levels associated with the one or more zones 104, according to an embodiment of the present invention;

FIG. 4A is a flowchart 400 illustrating an exemplary workflow for congestion bottleneck and root cause analysis thereof by the traffic congestion forecasting system, according to an embodiment of the present invention;

FIG. 4B illustrates a bottleneck identification trend over a time period, according to an embodiment of the present invention;

FIG. 4C illustrates an exemplary diagram showing visually overlaid bottleneck and root cause analysis thereof associated with the one or more zones 104 generated by the traffic congestion forecasting system 116, according to an embodiment of the present invention;

FIG. 5A illustrates an exemplary workflow 500 to optimize the timings of a traffic light by a recommendation module 218, according to an embodiment of the present invention;

FIGS. 5B and 5C illustrates an exemplary diagram illustrating a simulated traffic light simulation and a divergence route simulation respectively, according to an embodiment of the present invention;

FIG. 6A illustrates the top 10 congested roads in the one or more zones 104 selected by an operator 118, according to an embodiment of the present invention;

FIG. 6B illustrates the average congestion level on the main and highway roads of the one or more zones 104 selected by the operator, according to an embodiment of the present invention; and

FIGS. 6C and 6D illustrates the graph with the forecasted congestion and speed level associated with the one or more zones 104 according to an embodiment of the present invention.

### DETAILED DESCRIPTION OF THE INVENTION

Embodiments of the present invention are best understood by reference to the figures and description set forth herein. All the aspects of the embodiments described herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit and scope thereof, and the embodiments herein include all such modifications.

This description is generally drawn, inter alia, to methods, apparatuses, systems, devices, non-transitory mediums, and computer program products implemented as automated tools for congestion bottleneck identification and root cause analysis thereof.

The description strives to revolutionize the concept of automatically determining and presenting for congestion bottleneck and root cause analysis thereof.

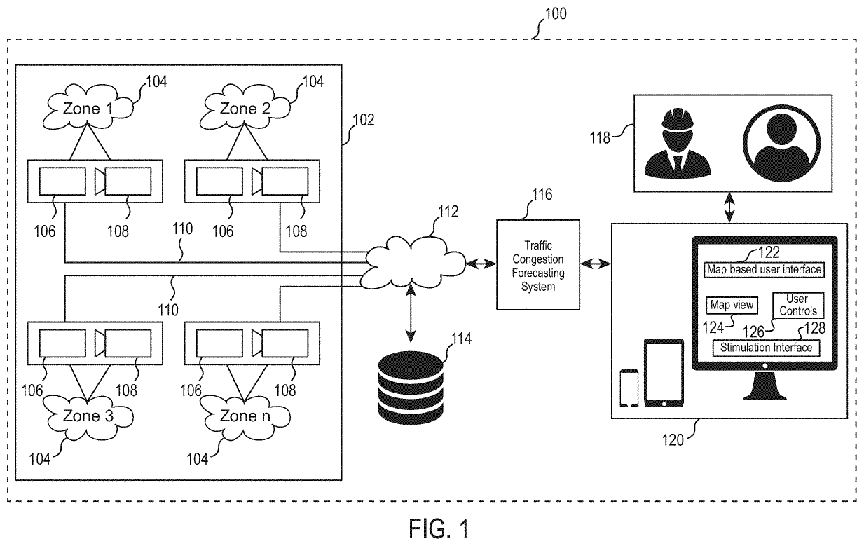

FIG. 1 schematically shows an exemplary environment 100 of a traffic congestion forecasting system 116 used for congestion bottleneck identification and root cause analysis thereof, in accordance with at least some embodiments described herein. The environment 100 comprises an area 102 having a plurality of zones 104. In an exemplary embodiment of the present invention, the area 102 can be such as, but not limited to, a country or a state, and each of the plurality of zones 104 can be such as, and without limitation, a city, a town, a junction, a roundabout, an intersection, a highway, a flyover, a main road, tourist attractions, hotels, shopping malls, a street, residential area, colony, and/or any other places of interest. Each zone 104 may comprise at least one of a first input source 106 and a second input source 108 to monitor traffic parameters associated with each of the plurality of zones 104. The traffic parameters can include one or more of real-time geographical & temporal parameters, real-time visual indicators, and a historical dataset associated with each of the plurality of zones 104.

According to another embodiment of the present invention, the first input source 106 can be a Geographic Information System (GIS). The Geographic Information System (GIS) can provide one or more real-time geographical and temporal parameters associated with each of the plurality of zones 104. The geographical and temporal parameters can include parameters such as, but not limited to, weather conditions, a real-time and historical geographic traffic pattern, a road elevation information, traffic information received from GPS devices in proximity of the zones 104, latitude/longitude details of the zones 104, road width, a news forecast of the zones 104, a real-time geographic travel pattern, traffic congestion duration at the zones 104, potential traffic hotspots and location thereof, information related to potential traffic obstruction points in vicinity of the zones 104, and peak time associated with traffic obstruction hotspots, other parameters such as humidity, temperature, dew point, pressure, atmospheric visibility, and wind speed associated with the one or more zones 104.

In an embodiment of the present invention, the first input source 106 can provide one or more real-time geographical & temporal parameters associated with a point of interest (POI) such as, but not limited to, the number of restaurants, cafes, fast food joints, museums, toilets, hospitals, administrative buildings, airports, hotels, petrol stations, shopping malls, parks, school, religious places and shops in the vicinity of the one or more zones 104. The one or more real-time geographical & temporal parameters can include such as, but not limited to, a traffic congestion level, duration of the congestion level, impact of the congestion level on the traffic, pattern of the traffic congestion over a period of time, peak hours of the traffic congestion at the point of interest (POI) present in the vicinity of the one or more zones 104.

According to another embodiment of the present invention, the first input source 106 may also provide one or more real-time temporal parameters associated with each of the plurality of zones 104. The temporal parameters associated with each of the plurality of zones 104 can be such as, but not limited to, traffic patterns observed during an hour, a month, a weekday, a public holiday, a national holiday, travel days or the like during a particular time frame.

According to an embodiment of the present invention, the second input source 108 can be a video source. The video source can provide one or more real-time visual indicators parameters associated with each of the plurality of zones 104 can be such as, but not limited to, visual data-feed captured by cameras installed in vicinity of at least one of the plurality of zones 104, data feeds from traffic light cameras, visual feeds from dashcams, visual feeds indicating traffic movement, visual feed indicating pedestrian movement, visual feed indicating road obstacles, visual feed received one or more video sensors, visual feed indicating people density in an geographical area, visual feeds indicating road accident, visual feeds indicating construction, and visual feeds indicating congestion density, visual feeds indicating effect of traffic congestion on the traffic movement, visual feeds indicating a public gathering event such as a concert, a sports event, a press conference, charity events, inauguration event etc.

The data provided by the first input source 106 and the second input source 108 is transmitted to a communication network 112 using a communication link 110 wherein the communication link 110 can be such as, but not limited to, wired communication link, wireless communication line, or hybrid communication link. The communication network 112 can be such as, but not limited to, Wi-Fi, cellular network, Local Area Network (LAN), Wide Area Network (WAN), Metropolitan Area Network (MAN), PSTN, internet, GPRS, GSM, CDMA network, Ethernet, wired connection, fibre optics, Bluetooth, ZigBee, NFC and so forth. The communication link 110 is utilized to transmit one or more of the real-time geographical & temporal parameters, the real-time visual indicators associated with each of the plurality of zones 104 to the communication network 112. The communication network 112 is suitably designed and configured to transmit the one or more of the real-time geographical & temporal parameters, the real-time visual indicators associated with each of the plurality of zones 104 to a database 114 and/or a traffic congestion forecasting system 116.

In another embodiment of the present invention, the database 114 can be deployed on premises, on cloud or in a hybrid environment. In an embodiment of the present invention, the database 114 is an integral part of a cloud based network. The database 114 can also be linked with third-party servers. The users of the third-party servers can be provided with authentication credentials to access the database 114. Such approach is beneficial in scenarios where the or more of the real-time geographical & temporal parameters, the real-time visual indicators associated with each of the plurality of zones 104 is provided by a third-party service provider. In an embodiment, the information stored in the database 114 (e.g. the real-time geographical & temporal parameters, the real-time visual indicators associated with each of the plurality of zones 104) is suitably encrypted to ensure protection of the information.

In an embodiment of the present invention, the database 114 can also store historical dataset associated with each of the plurality of zones 104. The historical dataset comprises one or more of past geographical & temporal parameters and effects thereof on past traffic congestion level, past visual indicators and effects thereof on past traffic congestion level, past bottleneck and past traffic congestion levels with associated root-cause thereof.

The historical dataset plays a vital role in predicting the traffic congestion level for a short-term and a long-term duration. The historical dataset associated with each of the plurality of zones 104 can be stored in the database 114 for different time periods such as, but not limited to, past years, a year, a month, a week, a day, an hour. The historical data associated with each of the plurality of zones 104 can also be stored for specific time duration such as, but not limited to, weekends, weekdays, holiday duration, peak hours duration during a day, a week, a month, a year. The historical dataset can also include traffic trends analyzed over a period of time associated with each of the plurality of zones 104. The trends can include parameters such as, bottleneck identified over a time period, root cause associated with the bottleneck, effect of bottleneck on the traffic congestion, strategies adapted to mitigate the traffic congestion levels, effects of one or more of the past geographical & temporal parameters and effects thereof on past traffic congestion level, past visual indicators on the strategies adapted to mitigate the traffic congestion levels, duration of traffic congestion and bottleneck associated with each of the plurality of zones 104, start and end time of the past congestion bottleneck identification and their toot cause analysis thereof.

In an embodiment of the present invention, the historical dataset can also include data associated with one or more countries having similar geographical conditions. The dataset associated with such countries can include one or more of past geographical & temporal parameters and effects thereof on past traffic congestion level, past visual indicators and effects thereof on past traffic congestion level, past bottleneck and past traffic congestion levels with associated root-cause thereof. In addition to this, the dataset can also include trends of traffic congestion and bottleneck along with the strategies adapted to mitigate the traffic congestion. Such historical dataset serves as an essential input to the traffic congestion forecasting system 116 as it includes cross domain traffic dataset which helps in accurately predicting shorter and longer duration traffic congestion levels, traffic bottleneck identification and root cause analysis thereof by integrating the one or more of the real-time real-time geographical & temporal parameters, real-time visual indicators associated with each of the one or more countries having similar geographical conditions.

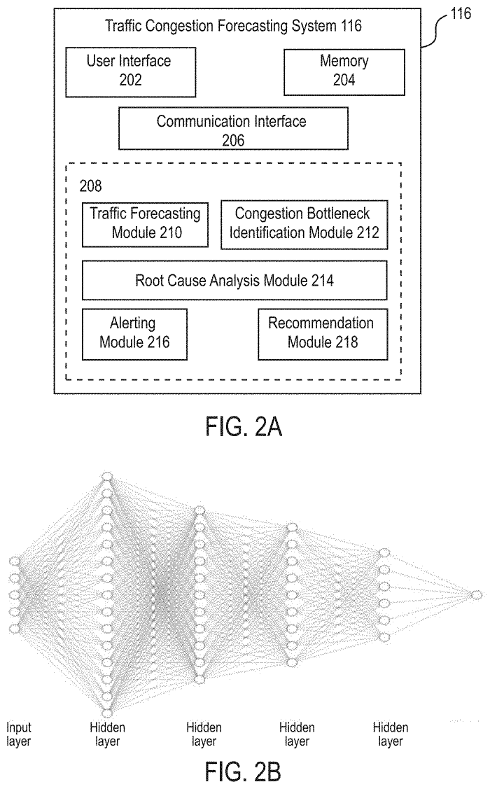

The traffic congestion forecasting system 116 is configured to retrieve from the database 114 one or more of real-time geographical & temporal parameters, real-time visual indicators and historical dataset associated with each of the plurality of zones 104 via utilizing the communication network 112. The traffic congestion forecasting system 116 is an automated system suitably designed and configured to forecast traffic congestion levels, congestion bottleneck identification and/or root cause analysis thereof. The traffic congestion forecasting system 116 can forecast traffic congestion levels, congestion bottleneck identification and root cause analysis thereof based on preferences received from an operator 118 of a user device 120. For example, the operator 118 can specify the location of the one or more zones 104, via using the user device 120, for which traffic congestion level is to be forecasted. Also, the operator 118 can specify, via using the user device 120, the desired time frame for which the traffic congestion level is to be forecasted. In addition, to this the traffic congestion forecasting system 116 can provide one or more simulated strategies to mitigate one or more of the traffic bottlenecks and the traffic congestion level wherein the simulated strategies comprises at least one of a traffic light timing simulation and a divergence route simulation. More details on the components and functioning of the traffic congestion forecasting system 116 is provided further in conjunction with FIGS. 2A and 2B of the present invention.

The traffic congestion forecasting system 116 is suitably programmed to provide the forecasted traffic congestion levels, congestion bottleneck identification and root cause analysis thereof to the operator 118 of the user device 120. The operator 118 can be such as, but not limited to, a traffic operator, a highway official, an administrative personnel, a traffic management agency, a driver, and a civilian. The user device 120 can be such as, but not limited to, a smart phone, a hand-held phone, a personal digital assistant (PDA), a tablet computer, a desktop computer, a portable scanner, a laptop computer, a smart watch, a wearable device or other similar device without departing from the spirit and scope of the present invention.

In an embodiment of the present invention, the user device 120 is installed with a service application (not shown) to communicate with the traffic congestion forecasting system 116. The operator can utilize the service application to view and analyze the forecasted traffic levels generated by the traffic congestion forecasting system 116 In another embodiment of the present invention, the user device 120 may be programmed to run a browser application and visit a webpage hosted by the traffic congestion forecasting system 116 to perform capabilities such as traffic congestion forecasting, bottleneck identification, and/or root cause analysis thereof.

The user device 120 provides a user interface to the operator 118 to make various selection for example, receiving inputs about location(s) associated with the one or more zones 104 for which the traffic congestion is to be forecasted. In another embodiment of the present invention, the service application may be implemented as an application program that may be executed by a processing unit of the user device 120 to perform analytics about the short term or long term traffic congestion level and/or bottleneck and root cause analysis thereof. Further, the service application installed in the user device 120 is configured to connect the operator 118 with the traffic congestion forecasting system 116 using industry standard communication. In yet another embodiment of the present invention, the application program is downloaded from the internet and installed on the user device 120. The traffic congestion forecasting system 116 provides the operator 118 of the user device 120 with login credentials i.e. a username and a password to access the application program. The traffic congestion forecasting system 116 is suitably programmed to visually overlay the forecasted traffic congestion levels, congestion bottlenecks and root causes thereof on a map. The traffic congestion forecasting system 116 facilitates the display of the map with the visually overlaid forecasted traffic congestion levels, congestion bottlenecks and root causes thereof on the user device 120 of the operator 118.

The application program of the user device 120 is suitably configured to receive information related to the forecasted traffic congestion levels, congestion bottlenecks and root causes thereof associated with the one or more zones 104 from the traffic congestion forecasting system 116 and transmit the received information in the form of an alert to the operator 118 of the user device 120. The alert can be an audio alert, a visual alert or the like.

When the operator 118 accesses the alert, the operator 118 is provided with the map having visually overlaid forecasted traffic congestion levels, congestion bottlenecks and root causes thereof on a map based user interface 122. In an embodiment of the present invention, the map based user interface 122 is configured to present congestion bottleneck identification and root cause analysis thereof associated with the one or more zones 104 on the map. In another embodiment of the present invention, the map based user interface 122 is configured to present one or more simulated strategies comprising at least one of a traffic light timing simulation and a divergence route simulation. The operator 118 can utilize the map view 124, via using the user device 120, to view the forecasted traffic congestion levels, congestion bottleneck identification and root cause analysis thereof associated with the each of the plurality of zones 104 in a more detailed manner. Different controls such as, but not limited to, zoom in, zoom out, save, edit, modify, share etc. may be provided by the user device 120 to the operator 118 to effectively access the forecasted traffic congestion levels, congestion bottleneck identification and root cause analysis thereof on the map view 124. In addition to this, the user device 120 of the operator 118 may also provide other generic controls under the user controls 126. The user controls 126 may include different controls such as, but not limited to, changing the user name and password provided by the traffic congestion forecasting system 116, permission control, accept or reject the determined one or more simulated strategies to mitigate one or more of the traffic bottlenecks and the traffic congestion level, formulate new stimulation strategies according to the received forecasted traffic congestion levels, bottleneck identification and root causes associated thereof, option to specify other operators with whom the stimulated strategies is to be shared wherein the other operators can be a traffic operator, highway official, an administrative personnel, traffic management agency, driver, and civilian other than the operator 118. For example, the user device 120 can provide the operator 118 with an option to share the one or more stimulated strategies with the other stakeholders to manage the traffic levels in the one or more zones 104 well in advance. The user device 120 of the operator is configured to transmit the one or more stimulated strategies in the form of an alert to the other operators. In an embodiment of the present invention, the user device 120 can provide the operator 118 with an option under the user controls 126 to generate a graph indicating the forecasted traffic congestion level, congestion bottleneck and root cause analysis thereof. In an embodiment of the present invention, the user device 120 can be configured to generate the graph in the form of a vein diagram, a pie chart, a bubble chart, or the like. In an embodiment of the present invention, the user device 120 can provide the operator 118 an option to specify a time period for which the graph is to be generated. In another embodiment of the present invention, the user device 120 can generate the graph or both historical and real-time data associated with the each of the plurality of the zones 104.

In an embodiment of the present invention, the user device 120 of the operator 118 is suitably configured to provide the operator 118 with an option to modify the determined one or more simulated strategies to mitigate one or more of the traffic bottlenecks and the traffic congestion level by using a stimulation interface 128. The stimulation interface 128 of the user device 120 is programmed to generate the modified one or more simulated strategies to mitigate one or more of the traffic bottlenecks and the traffic congestion level based on input from the operator 118, via using the user device 120,

In an embodiment of the present invention, application program running on the user device 120 is suitably programmed to provide different user interfaces with different controls to different operators 118. For example, the application program may be programmed to exclude the stimulation interface 128 to formulate the strategies to control traffic associated with the one or more zones 104 from the user device 120 of a civilian. Therefore, the application program can provide different user controls 126 for different operators 118 according to their designation (i.e. if the operator 118 of the user device 120 is a civilian or a traffic official).

More details on the components and functioning of the traffic congestion forecasting system 116 is provided further in conjunction with FIGS. 2A and 2B of the present invention.

FIG. 2A schematically shows a block diagram of the traffic congestion forecasting system 116 for congestion bottleneck identification and root cause analysis thereof according to an embodiment of the present invention. The traffic congestion forecasting system 116 includes different modules which work together to analyze the received one or more of the real-time geographical & temporal parameters, the real-time visual indicators, the historical dataset associated with each of the plurality of zones 104 to perform traffic congestion forecasting, congestion bottleneck identification and root cause analysis thereof. The analysis provides a substantial time span of several hours in advance for the operator 118 to act on the forecasted traffic congestion levels and congestion bottleneck identification to formulate a proactive strategy for traffic management before such forecasted scenarios actually appear. The traffic congestion forecasting system 116 comprises a user interface 202. The user interface 202 can be any interface known in the art, such as, Graphical User interface (e.g. LCD, LED display, etc.), touchscreen, keyboard, mouse, keypad and combination thereof. In an embodiment of the present invention, the user interface 202 is configured to display the forecasted traffic congestion levels, bottleneck identification and root cause analysis thereof, one or more strategies to mitigate the traffic congestion levels and the bottleneck identification associated with the one or more zones 104. In another embodiment of the present invention, the user interface 202 is also configured to receive input from the operator 118, via using the user device 120, or from a system operator, to operate the traffic congestion forecasting system 116.

The traffic congestion forecasting system 116 comprises a memory 204 which stores a suitably programmed computer program product which when executed by the traffic congestion forecasting system 116 performs the various traffic congestion forecast, bottleneck identification and root cause analysis thereof. In one another embodiment of the present invention, the memory 204 also stores instructions related to the application program. The application program may be used to operate the traffic congestion forecasting system 116. The application program can be operated in multiple languages. In one embodiment of the present invention, the application program is downloaded from the internet and installed on the traffic congestion forecasting system 116. In another embodiment of the present invention, the application program is pre-installed or in-built in the traffic congestion forecasting system 116. In yet another embodiment of the present invention, the application program may be implemented as an application program (or combination of software and hardware). In another embodiment of the present invention, the application program may be in communication with a processing unit of traffic congestion forecasting system 116 to perform analytics about the short term or long term traffic congestion level and/or bottleneck and root cause analysis thereof.

In an embodiment of the present invention, the memory 204 can also store the historical dataset associated with each of the plurality of zones 104. The historical dataset comprises one or more of past geographical & temporal parameters and effects thereof on past traffic congestion level, past visual indicators and effects thereof on past traffic congestion level, past bottleneck and past traffic congestion levels with associated root-cause thereof. The historical dataset plays a vital role in predicting the traffic congestion level for a short-term and a long-term duration. The historical dataset associated with each of the plurality of zones 104 can be stored in the database 114 for different time periods such as, but not limited to, past years, a year, a month, a week, a day. The historical data associated with each of the plurality of zones 104 can also be stored for specific time duration such as, but not limited to, weekends, weekdays, holiday duration, peak hours duration during a day, a week, a month, a year. The historical dataset can also include traffic trends analyzed over a period of time associated with each of the plurality of zones 104. The trends can include parameters such as, bottleneck identified over a time period, root cause associated with the bottleneck, effect of bottleneck on the traffic congestion, strategies adapted to mitigate the traffic congestion levels, effects of one or more of the past geographical & temporal parameters and effects thereof on past traffic congestion level, past visual indicators on the strategies adapted to mitigate the traffic congestion levels, duration of traffic congestion and bottleneck associated with each of the plurality of zones 104. In another embodiment of the present invention, the historical dataset can be received from the database 114.

The traffic congestion forecasting system 116 comprises a communication interface 206 for performing communication with the database 114 and/or the operator 118 of the user devices 120 via connecting to the communication network 112. The communication interface 206 can be, but not limited to, Ethernet port, Bluetooth, Wi-Fi, LAN interface, NFC, Zigbee, Infrared port, cellular interface, radio interface, fibre optic port, USB port, IEEE compliant interface or any other method known in the prior art.

The traffic congestion forecasting system 116 further comprises an analysis module 208 comprising traffic forecasting module 210, congestion bottleneck identification module 212, root cause analysis module 214, alerting module 216, recommendation module 218. The traffic forecasting module 210 is configured to receive one or more of the real-time geographical & temporal parameters, real-time visual indicators from the first input source 106 and the second input source 108 respectively via the communication network 112. The traffic forecasting module 210 is also configured to receive historical dataset associated with each of the plurality of zones 104 from the database 114 via the communication network 112 or from the memory 204. The traffic forecasting module 210 is suitably programmed to analyses the received one or more of the real-time geographical & temporal parameters, real-time visual indicators, historical dataset and forecast traffic congestion levels for one or more of the plurality of zones 104. The traffic forecasting module 210 executes different algorithms as described in conjunction with FIG. 2B of the present invention to forecast traffic congestion level associated with the one or more of the plurality of zones 104. The historical dataset acts as the basis to determine the congestion level for the one or more of the plurality of zones 104. In one exemplary embodiment of the present invention, the traffic forecasting module 210 receives input from the operator 118 via the user device 120. The input received from the user device 120 specifies the location of one of the plurality of zones for which the traffic congestion congestion levels are to be predicted. The traffic forecasting module 210 analyses the historical dataset associated with the one of the plurality of zones 104. The historical dataset may include past forecasted congestion level associated with the one of the plurality of zones 104, one or more determined strategies to mitigate the forecasted traffic congestion level associated with the one of the plurality of zones 104, trends associated with the control of the forecasted traffic congestion level associated with the one of the plurality of zones 104, time and duration of the forecasted traffic congestion level associated with the one of the plurality of zones 104, implemented strategies to mitigate the forecasted traffic congestion level associated with the one of the plurality of zones 104, one or more of the past geographical, visual indicators associated with the one of the plurality of zones 104.

In one embodiment of the present invention, the traffic forecasting module 210 is suitably programmed to compare the historical dataset associated with the one of the plurality of zones 104 with the received one or more of the real-time geographical & temporal parameters, real-time visual indicators, historical dataset associated with each of the plurality of zones 104 to forecast the traffic congestion level at the one of the plurality of zones 104. In an embodiment of the present invention, the traffic forecasting module 210 determines a similarity level between the historical dataset associated with the one of the plurality of zones 104 and the received one or more of the real-time geographical & temporal parameters, real-time visual indicators, historical dataset associated with each of the plurality of zones 104. Based on the determined similarity level and the analysis of the one or more of the real-time geographical & temporal parameters, real-time visual indicators, historical dataset associated with each of the plurality of zones 104, the traffic forecasting module 210 forecasts the traffic congestion level at the one of the plurality of zones 104. This approach saves the computational time and makes the forecasted traffic congestion level at the one of the plurality of zones 104 more accurate, as the historical dataset which has been used to forecast the traffic congestion level at the one of the plurality of zones 104 in the past helps in more reliable prediction of the traffic congestion level associated with the one of the plurality of zones 104.

In an embodiment of the present invention, the traffic forecasting module 210 may compare the forecasted traffic congestion level associated with the one of the plurality of zones 104 with a threshold level associated with the one of the plurality of zones 104 to determine an alert condition. The alert condition may indicate that the forecasted traffic congestion level associated with the one of the plurality of zones 104 is above the threshold level. Therefore, the operator 118 needs to be alerted regarding the forecasted traffic congestion level associated with the one of the plurality of zones 104 so that the operator 118 can manage the traffic levels well in advance.

In an embodiment of the present invention, the traffic forecasting module 210 is configured to forecast the traffic congestion level for all of the plurality of the zones 104 by using the real-time geographical & temporal parameters, real-time visual indicators, historical dataset associated with the one or more of the plurality of the zones 104 depending on the operator 118 requirement.

The forecasted traffic congestion level predicted by the traffic forecasting module 210 is transmitted to the congestion bottleneck identification module 212 for further analysis. The congestion bottleneck identification module 212 identifies the bottlenecks associated with the one or more of the plurality of the zones 104. The bottleneck represents the areas or the points which contribute majorly to the traffic congestion such as, but not limited to, a petrol station, a school, a shopping mall, a restaurant, a cafe, an administrative building or the like. The congestion bottleneck identification module 212 receives one or more of the real-time geographical & temporal parameters, real-time visual indicators, historical dataset associated with each of the plurality of zones 104. The congestion bottleneck identification module 212 receives one or more of the real-time geographical & temporal parameters, real-time visual indicators from the first input source 106 and the second input source 108 respectively via the communication network 112. The congestion bottleneck identification module 212 is also configured to receive historical dataset associated with each of the plurality of zones 104 from the database 114 via the communication network 112 or from the memory 204. The congestion bottleneck identification module 212 uses the one or more of the real-time geographical & temporal parameters, real-time visual indicators, historical dataset associated with each of the plurality of zones 104 to identify the bottlenecks in the each of plurality of zones 104. For example, the congestion bottleneck identification module 212 receives the forecasted traffic congestion value associated with the one of the plurality of zones 104 determined by the traffic forecasting module 210. The congestion bottleneck identification module 212 utilizes the historical dataset associated with each of the plurality of zones 104 to identify the past bottleneck pattern associated with the one of the plurality of zones 104. The past bottleneck pattern helps in identifying the past trends of the bottleneck pattern in the one of the plurality of zones 104. In an embodiment of the present invention, the one of the plurality of zones 104 includes a petrol station situated on a high elevated road in the one of the plurality of zones 104. The petrol pump may have served as an important congestion bottleneck in the past. The past bottleneck pattern helps in identifying the duration for which the petrol pump was a bottleneck in the past along with its peak bottleneck hours, the effect of the road elevation on the petrol pump in the past which contributed towards the formation of the bottleneck. The congestion bottleneck identification module 212 identifies the one or more of the real-time geographical & temporal parameters, real-time visual indicators, historical dataset associated with the one of the plurality of zones 104 from the one or more of the real-time geographical & temporal parameters, real-time visual indicators, historical dataset associated with each of the plurality of zones 104.

The congestion bottleneck identification module 212 compares the identified one or more of the real-time geographical & temporal parameters, real-time visual indicators, historical dataset associated with the one of the plurality of zones 104 with the identified bottleneck pattern from the past historical dataset associated with the one of the plurality of zones 104 to identify the bottleneck associated with the one of the plurality of zones 104. The use of the historical dataset associated with the one of the plurality of zones 104 helps in efficiently identifying the bottlenecks associated with the one of the plurality of zones 104.

In an embodiment of the present invention, the congestion bottleneck identification module 212 is configured to identify traffic bottleneck for all of the plurality of the zones 104 by using the real-time geographical & temporal parameters, real-time visual indicators, historical dataset associated with the one or more of the plurality of the zones 104 depending on the operator 118 requirement.

The congestion bottleneck identification module 212 transmits the determined bottleneck associated with the one of the plurality of zones 104 to the root cause analysis module 214. The root cause analysis module 214 analyses the cause for the bottleneck formation associated with the one of the plurality of zones 104. The root cause analysis module 214 is configured to receive the historical data set associated with the plurality of zones 104 from the database 114 via the communication network 112 or from the memory 204. The root cause analysis module 214 utilizes the historical data set associated with the plurality of zones 104 to identify the historical dataset associated with the one of the plurality of zones 104. The identified historical dataset associated with the one of the plurality of zones 104 is used to identify the past root cause analysis to identify the reasons which led to the formation of the bottleneck in the one one of the plurality of zones 104.

For example, the congestion bottleneck identification module 212 identifies that the petrol station situated on a high elevated road as the bottleneck for the one of the plurality of zones 104. The root cause analysis module 214 analyses the reasons which led to the formation of the bottleneck i.e. traffic agglomeration around the petrol pump in the past. The analysis may include such as, but not limited to, analyzing the road elevation data, analyzing the peak hours of the traffic bottleneck, analyzing the effect of the road elevation on the formation of the traffic bottleneck, analyzing trends of the formation of the traffic bottleneck over a time period. Such analysis helps in identifying the past reasons which lead to the formation of the traffic agglomeration around the petrol pump i.e. bottleneck. The root cause analysis module 214 uses the derived root cause analysis from the past historical dataset associated with the one of the plurality of zones 104 to analyze the effect of the past root cause analysis on the real-time geographical & temporal parameters, real-time visual indicators associated with the one of the plurality of zones 104. In an embodiment of the present invention, the root cause analysis module 214 may determine that the road elevation was the major reason behind the formation of the bottleneck in the past. The root cause analysis module 214 may determine the real-time road elevation data from the real-time geographical & temporal parameters associated with the one of the plurality of zones 104 to determine the effect of the road elevation on the real-time formation of the bottleneck in the one of the plurality of zones 104. The root cause analysis module 214 may also use the real-time visual indicators associated with the one of the plurality of zones 104 such as visual feed indicating people density in a geographical area to determine the more accurate root cause associated with the formation of the bottleneck in the one of the plurality of zones 104. Such analysis helps in determining more concrete root cause analysis as the real-time geographical & temporal parameters, real-time visual indicators associated with the one of the plurality of zones 104 may or may not indicate the trends and patterns of the bottleneck identified in the one or more of the plurality of zones 104.

In an embodiment of the present invention, the root cause analysis module 214 is configured to perform the root cause analysis for all of the plurality of the zones 104 by using the real-time geographical & temporal parameters, real-time visual indicators, historical dataset associated with the one or more of the plurality of the zones 104 depending on the operator 118 requirement.

The forecasted traffic congestion level by the traffic forecasting module 210, bottleneck identified by the congestion bottleneck identification module 212 and the root cause analysis associated with the bottleneck identified by the root cause analysis module 214 are provided as input to the alerting module 216. The alerting module 216 uses the forecasted traffic congestion level, bottleneck identified along with their root cause analysis thereof associated with the one of the plurality of zones 104 to alert the user device 120 of the operator 118 with the identified forecasted traffic congestion level, bottleneck identified along with their root cause analysis thereof associated with the one of the plurality of zones 104.

In an embodiment of the present invention, the alerting module 216 may be operated by an administrator of the traffic congestion forecasting system 116. In another embodiment of the present invention, the alerting module 216 may be automatically operated by the traffic congestion forecasting system 116 by using the method described in FIG. 2B of the present invention.

The alerting module 216 maintains the alert type and the list of operators who are to be notified in case of an alert condition. The alert type and the other operators which are to be alerted in case of an alert condition may be specified by the operator 118, via using the user device 120, In an embodiment of the present invention, the alert type can include such as, but not limited to, an audio alert, a visual alert or the like and the other operators can be such as, but not limited to, traffic operator, highway official, an administrative personnel, traffic management agency, driver, civilian other than the operator 118. The operator 118, via using the user device 120, may also specify the duration after which the alert is to be generated such as, but not limited to, hourly, weekly, monthly, yearly duration. In an embodiment of the present invention, the alerting module 216 may be configured automatically send the alert the operator 118 or the other operators in case the alerting module 216 does not have the data associated with the operators who are to be alerted, the duration after which the alert is to be generated.

In an embodiment of the present invention, the alert can include one or more recommendation strategies generated by the recommendation module 218 to mitigate the traffic bottlenecks and the traffic congestion level at the one of the plurality of zones 104. The recommendation module 218 receives one or more of the real-time geographical & temporal parameters, real-time visual indicators from the first input source 106 and the second input source 108 respectively via the communication network 112. The recommendation module 218 is also configured to receive historical dataset associated with each of the plurality of zones 104 from the database 114 via the communication network 112 or from the memory 204. The recommendation module 218 utilizes the received historical dataset associated with each of the plurality of zones 104 to identify the historical dataset associated with one of the plurality of zones 104. The historical dataset associated with one of the plurality of zones 104 is used to analyze the past strategies recommended and performed to mitigate the traffic bottlenecks and the traffic congestion level at the one of the plurality of zones 104. This analysis helps in identifying the one or more strategies adapted in past to efficiently manage the traffic bottlenecks and the traffic congestion level at the one of the plurality of zones 104. The recommendation module 218 utilizes the past one or more strategies with the real-time geographical & temporal parameters, real-time visual indicators associated with one of the plurality of zones 104 to amend the past one or more strategies in way to accurately control the traffic bottlenecks and the traffic congestion level at the one of the plurality of zones 104. The one or more strategies generated by the recommendation module 218 to mitigate the traffic bottlenecks and the traffic congestion level at the one of the plurality of zones 104 is provided to the operator 118 along with the alert.

In an embodiment of the present invention, the traffic congestion forecasting system 116 is suitably programmed to provide the traffic bottlenecks and the traffic congestion level at the one of the plurality of zones 104 in form of a visual simulation. The traffic congestion forecasting system 116 is configured to visually overlay the traffic bottlenecks and the traffic congestion level at the one of the plurality of zones 104 on the map. The visual simulation may indicate the implementation of the one or more strategies to mitigate the traffic bottlenecks and the traffic congestion level at the one of the plurality of zones 104 in real-time. The real-time implementation helps in assisting the operator 118 to select the most appropriate strategy to mitigate the traffic bottlenecks and the traffic congestion level. The different modules of the traffic congestion forecasting system 116 work together to predict the traffic congestion level and the traffic bottlenecks and the root cause analysis thereof.

The principle for functioning of the analysis module 208 is described in conjunction with FIG. 2B of the present invention.

FIG. 2B illustrates an exemplary workflow to predict congestion bottleneck identification and root cause analysis thereof, according to an embodiment of the present invention. The analysis module 208 using an artificial intelligence model based on a feedforward neural network to analyze and recognize patterns in the received one or more of real-time geographical & temporal parameters, real-time visual indicators, a historical dataset associated with each of the plurality of zones 104. The feedforward neural network is used to predict traffic congestion bottleneck identification and root cause analysis thereof associated with the one or more of the plurality of zones 104. In an exemplary embodiment of the present invention, the feedforward neural network forecasts the traffic predictions for the next 12 hours with half-hour intervals between predictions. In another exemplary the present invention, the traffic forecast can be generated for operator 118 defined time frame, via using the user device 120, wherein the time frame can be such as, but not limited to, an hourly, daily, weekly, or monthly time frame. In some examples, the time frame may include a date range where the operator 118, via using the user device 120, provides a start date and an end date.

The network architecture of the feedforward neural network includes one input layer, four hidden layers and one output layer. In an exemplary environment, the network architecture of the feedforward neural network includes one input layer having 19 values, four hidden layers having 512, 256, 128, 64 neurons respectively and one output layer having a single neuron. One skilled in the art will appreciate that 19 values for input layer has been described for the purpose of illustrations and not limitation. Any number of inputs with regard to the input layer throughout the methods described herein shall be considered within the spirit and scope of the present description.

The network architecture executes different processes such as, but not limited to, an activation function, batch normalization and training to generate traffic forecast bottleneck identification and root cause analysis thereof associated with the one or more of the plurality of the zones 104. The activation function takes input in the form of a single neuron and performs non-linear mathematical operation on the received input neuron. In an exemplary embodiment of the present invention ReLU activation is used as an activation function. The ReLU activation function does not stimulate all neurons simultaneously thereby making the computation efficient. In another exemplary embodiment of the present invention, sigmoid, tanh and other activation functions can also be used.

After the activation function is completed, the process moves to the batch normalization process. The batch normalization process is used to automatically standardize the inputs to the layer in a deep learning neural networks. This process also accelerates the training process of the network and the performance of the feedforward network can be improved. It also reduces the quantity by which the hidden unit values shift around.

After the competition of the batch normalization process, the neural network is trained. The training process of the neural network involves the calculation of loss function based on differences among input pixel values and ground truth values. Weight computation is dependent on the value of the loss. The losses can be optimized using different optimizers such as gradient descent, Adagrad, AdaDelta, Adam optimizers. In an exemplary embodiment of the present invention, the Adam optimizer is used to optimize the losses generated during the training process of the feedforward neural network. The final output layer of the feedforward neural network is used to forecast congestion levels, bottleneck identification associated with the one or more of the plurality of the zones 104 for a shorter time interval. The output generated from the output layer is fed back to the input layer and the process is repeated to get a forecast for a longer duration interval. Thereby making the network model function as a regression model.

One skilled in the art will appreciate that feedforward neural network with regard to traffic congestion level, bottleneck identification and root cause analysis associated with the one or more of the plurality of the zones 104 thereof has been described for the purpose of illustrations and not limitation. Any different types of algorithms and techniques such as tree based algorithm, bayesian algorithm, fuzzy networks, machine learning or the like throughout the methods described herein shall be considered within the spirit and scope of the present description.

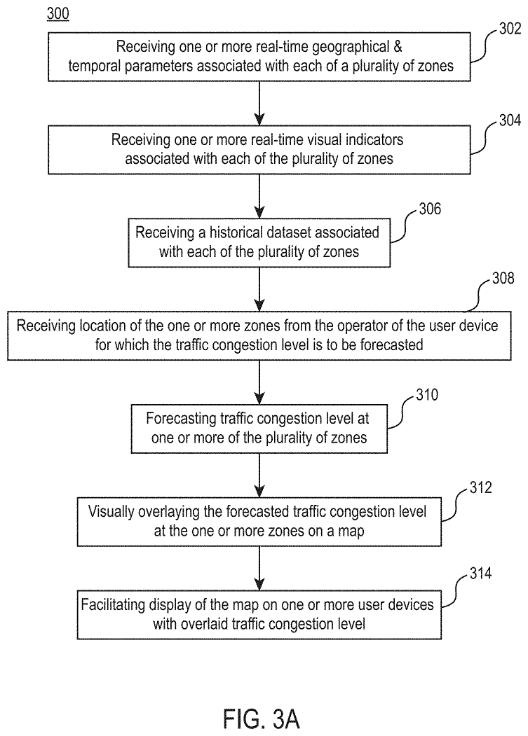

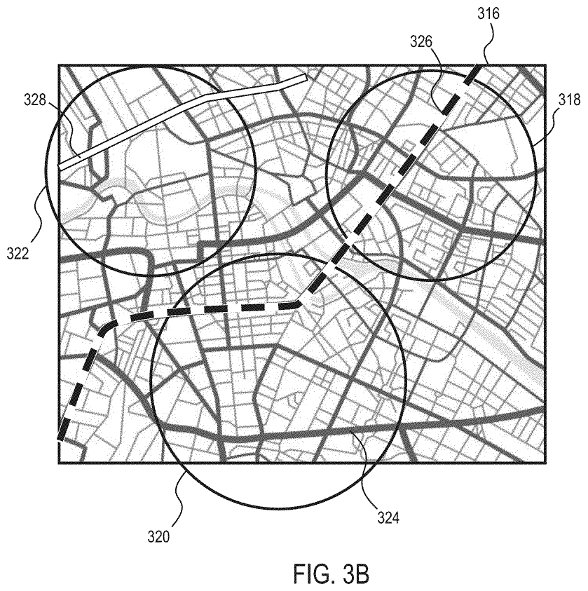

FIG. 3A is a flowchart 300 illustrating an exemplary workflow for forecasting a traffic congestion level at one or more of the plurality of zones 104 by a traffic congestion forecasting system, according to an embodiment of the present invention. In a particular embodiment, although the claimed subject matter is not limited in this respect, some portion of process embodiment 400 may be executed and/or performed by a suitably configured traffic congestion forecasting system 116 and/or a portion of process may be implemented by the user device 120.

The process begins at step 302, wherein the traffic congestion forecasting system 116 receives one or more real-time geographical & temporal parameters associated with each of a plurality of zones 104 wherein each zone 104 of the plurality of zones 104 can be a city, a town, a junction, a highway, a flyover, a main road, a sector, a street etc. The one or more real-time geographical & temporal parameters associated with each of a plurality of zones 104 is received from the first input source 106 via the communication network 112 as described in FIG. 1 of the present invention. In an embodiment of the present invention, the first input source 106 is a Geographic Information System (GIS) and provides the one or more real-time geographical & temporal parameters associated with each of a plurality of zones 104 such as, but not limited to, weather conditions, a real-time and historical geographic traffic pattern, a road elevation information, traffic information received from GPS devices in proximity of the zones 104, latitude/ longitude details of the zones 104, road width, a news forecast of the zones 104, a real-time geographic travel pattern, traffic congestion duration at the zones 104, potential traffic hotspots and location thereof, information related to potential traffic obstruction points in vicinity of the zones 104, and peak time associated with traffic obstruction hotspots, other parameters such as humidity, temperature, dew point, pressure, atmospheric visibility, and wind speed associated with the one or more zones 104. In an embodiment of the present invention, the first input source 106 can provide one or more real-time geographical & temporal parameters associated with a point of interest (POI) such as, but not limited to, the number of restaurants, cafes, fast food joints, museums, toilets, hospitals, administrative buildings, airports, hotels, petrol stations, shopping malls, parks, school, religious places and shops in the vicinity of the one or more zones 104. The one or more real-time geographical & temporal parameters associated with a point of interest (POI) can include traffic congestion level, duration of congestion level, impact of congestion level on the traffic level, pattern of traffic congestion over a period of time, peak hours of traffic congestion at the point of interest (POI) present in the vicinity of the one or more zones 104. The temporal parameters associated with each of the plurality of zones 104 can include such as, but not limited to, hour, month, weekday, public holiday, national holiday, travel days, speed, trends observed in the traffic patterns during a time frame. The one or more real-time geographical & temporal parameters associated with each of the plurality of zones 104 indicates the geographical & temporal conditions associated with each of the plurality of zones 104 in real-time.

At step 304, the traffic congestion forecasting system 116 receives one or more real-time visual indicators associated with each of the plurality of zones 104. The one or more real-time visual indicators associated with each of the plurality of zones 104 can be received from the second input source 108 via the communication network 112 as described in FIG. 1 of the present invention. In an embodiment of the present invention, the second input source 108 is a video source and provides the one or more visual indicators associated with each of a plurality of zones 104 such as, but not limited to, visual data-feed captured by cameras installed in vicinity of at least one of the plurality of zones 104, data feeds from traffic light cameras, visual feeds from dashcams, visual feeds indicating traffic movement, visual feed indicating pedestrian movement, visual feed indicating road obstacles, visual feed received one or more video sensors, visual feed indicating people density in an geographical area, visual feeds indicating road accident, visual feeds indicating construction, and visual feeds indicating congestion density, visual feeds indicating effect of traffic congestion on the traffic movement, visual feeds indicating a public gathering event such as a concert, a sports event, a press conference, charity events, inauguration event etc. The one or more visual indicators associated with each of the plurality of zones 104 indicates the real-time visually captured conditions associated with each of the plurality of zones 104.

At step 306, the traffic congestion forecasting system 116 receives a historical dataset associated with each of the plurality of zones 104. In an embodiment of the present invention, the historical dataset can be stored in the memory 204 of the traffic congestion forecasting system 116. In another embodiment of the present invention, can be received from the database 114 via the communication network 112. The historical dataset comprises one or more of past geographical & temporal parameters and effects thereof on past traffic congestion level, past visual indicators and effects thereof on past traffic congestion level, past bottleneck and past traffic congestion levels with associated root-cause thereof. The historical dataset plays a vital role in predicting the traffic congestion level for a short-term and a long-term duration. The historical dataset associated with each of the plurality of zones 104 can be stored in the database 114 or the memory 204 for different time periods such as, but not limited to, past years, a year, a month, a week, a day. The historical data associated with each of the plurality of zones 104 can also be stored for specific time duration such as, but not limited to, weekends, weekdays, holiday duration, peak hours duration during a day, a week, a month, a year. The historical dataset can also include traffic trends analyzed over a period of time associated with each of the plurality of zones 104. The traffic trends can include parameters such as, bottleneck identified over a time period, root cause associated with the bottleneck, effect of bottleneck on the traffic congestion, strategies adapted to mitigate the traffic congestion levels, effects of one or more of the past geographical & temporal parameters and effects thereof on past traffic congestion level, past visual indicators on the strategies adapted to mitigate the traffic congestion levels, duration of traffic congestion and bottleneck associated with each of the plurality of zones 104. In another embodiment of the present invention, the historical dataset can be received from the database 114.

At step 308, the traffic congestion forecasting system 116 receives location of the one or more zones 104 for which the traffic congestion level is to be forecasted from the operator 118, via using the user device 120. For example, the operator 118 may be in charge of a specific number of zones 104 and may wish to analyze the traffic congestion level corresponding to the specific number of zones 104. In such scenario, the operator 118 of the user device 120 may specify the location of the one or more zones 104 for which the traffic congestion level is to be forecasted. In another embodiment of the present invention, the operator 118, via using the user device 120, may also specify the desired time frame for which the traffic is to be forecasted. The desired time fame can be selected from hourly, monthly, weekly, yearly time frame. In some examples, the time frame may include a date range where the operator 118, via using the user device 120, provides a start date and an end date.

At step 310, the traffic congestion forecasting system 116 transmits the one or more of real-time geographical parameters, real-time visual indicators and the historical dataset associated with the one or more zones 104 for which traffic congestion level is to be predicted to the traffic forecasting module 210 of the traffic congestion forecasting system 116. The traffic congestion forecasting system 116 analyzes the historical dataset associated with the one or more zones 104 to determine past traffic congestion levels, effects of the past traffic congestion levels on the traffic, time and duration of the past traffic congestion levels, parameters responsible for the past traffic congestion levels associated with the one or more zones 104. The analyzed historical data set is then compared with the real-time geographical parameters, real-time visual indicators associated with the one or more zones 104 to find the similarity and differences between the past and the real-time conditions associated with the one or more zones 104. For example, the one or more zones 104 for which the traffic congestion level is to be forecasted includes a highway connected with a traffic junction. The past traffic congestion levels associated with the one or more zones 104 indicate that during a particular time period of the year such as monsoon period the traffic congestion levels have been high during the past. In another embodiment of the present invention, the past traffic congestion levels associated with the one or more zones 104 indicate that during a particular time period of the year, the highway undergoes a yearly maintenance. The traffic forecasting module 210 of the traffic congestion forecasting system 116 utilize this data to study the pattern of the traffic congestion levels associated with the one or more zones 104 to forecast a more accurate traffic congestion level. The traffic forecasting module 210 compare the trends generated from the historical dataset to study the one or more real-time geographical parameters, real-time visual indicators associated with the one or more zones 104. For example, the one or more real-time geographical parameters may indicate that the humidity level and the weather conditions associated with the one or more zones 104 indicates a monsoon period, the one or more real-time visual indicators associated with the one or more zones 104 indicate that the slow movement of traffic due to the monsoon period. Therefore, in such scenario, the traffic forecasting module 210 combines the observations generated from the historical data set and the one or more real-time geographical parameters and the one or more real-time visual indicators associated with the one or more zones 104 to forecast the traffic congestion level associated with the one or more zones 104.

In an embodiment of the present invention, the traffic forecasting module 210 of the traffic congestion forecasting system 116 may compare the forecasted traffic congestion level with a threshold level. The threshold level may be defined by the operator 118, via the user device 120, or may be automatically decided by the traffic forecasting module 210. If the forecasted traffic congestion level associated with the one or more zones 104 exceeds the threshold level, an alert may be issued to the user device 120 of the operator 118 indicating the forecasted traffic congestion levels associated with the one or more zones 104. In an embodiment of the present invention, the alert type can include such as, but not limited to, an audio alert, a visual alert or the like. Such forecasted traffic levels are more reliable and accurate as they are generated on the analysis of both historical and real-time parameters associated with the one or more zones 104. As in some scenarios, the real-time data may not point out the traffic problems which are observed by analyzing the historical dataset associated with the one or more zones 104.

At step 312, the traffic congestion forecasting system 116 is configured to visually overlaid the traffic congestion levels associated with the one or more zones 104 on the map. The overlaid forecasted traffic congestion levels helps the operator 118, via using the user device 120, to analyze the traffic congestion levels conveniently as the operator 118, via using the user device 120, can view the detailed forecast of the one or more zones 104 at the same time.

At step 314, the traffic congestion forecasting system 116 is suitably programmed to facilitate the display of the map with overlaid traffic congestion levels on one or more user devices 120 of the operator 118. The traffic congestion forecasting system 116 is configured to transmit the map with the visually overlaid traffic congestion levels to the user device 120 of the operator 118 in the form of an alert. The user device 120 of the operator 118 helps in convenient access of the map with overlaid traffic congestion levels associated with the one or more zones 104 by using the user controls 126 as described in the FIG. 1 of the present invention. The user device 120 of operator 118 is programmed to allow the operator 118 to share the forecasted traffic congestion levels associated with the one or more zones 104 to other operators associated with the administration of the one or more zones 104. The traffic congestion forecasting system 116 can generate the forecasted traffic congestion levels for both short duration and long duration depending on the operator 118 input, via using the user device 120.

In an embodiment of the present invention, if the operator 118 is a traffic official, the forecasted traffic congestion levels associated with the one or more zones 104 helps to manage the traffic well in advance. Therefore, reduces the instances of traffic jams, reduces environment pollution caused due the emissions produced by the vehicles waiting in the traffic jams, mitigates unsafe driving conditions and increases the safety of the people. In another embodiment of the present invention, if the operator 118 is a civilian or a driver, the forecasted traffic congestion levels associated with the one or more zones 104 helps the operator 118 to manage the driving behaviors well in advance. For example, if the operator 118, via using the user device 120, selects a longer duration such as a week or a month to generate the traffic congestion level associated with the one or more zones 104. The forecasted traffic level provides a significant time frame to manage the travel patterns according to the traffic congestion levels forecasted associated with the one or more zones 104. This directly reduces the mental stress of the operator 118, fuel consumption caused due to long waiting times, normalizes the travel time and thereby improves the lifespan of the operators of the one or more zones 104.

FIG. 3B illustrates an exemplary map 316 with visually overlaid traffic congestion levels associated with the one or more zones generated by the traffic congestion forecasting system 116, according to an embodiment of the present invention. The map 316 shows the forecasted traffic congestion level for one or more zones 318, 320 and 322. The map 316 may be presented in the form of an alert on the user device 120 of the operator 118. The intensity of the forecasted traffic congestion levels associated with the one or more zones 318, 320 and 322 can be differentiated with different patterns (e.g. with different colors). For example, the areas in the one or more zones 318, 320 and 322 having the highest forecasted traffic congestion level can be shown with a dense pattern 324 (e.g. first color pattern), the areas in the one or more zones 318, 320 and 322 having the medium forecasted traffic congestion level can be shown with an intermediate pattern 326 (e.g. second color pattern) and the one or more zones 318, 320 and 322 having the least forecasted traffic congestion level can be shown with no pattern 328.

In an embodiment of the present invention, the forecasted traffic congestion level patterns can be altered according to the operator 118 requirement. The forecasted traffic congestion level displayed on the map can include different details such as, start time of the forecasted traffic congestion level associated with the one or more zones 318, 320 and 322, end time of the forecasted traffic congestion level associated with the one or more zones 318, 320 and 322, latitude and longitudinal co-ordinates of the areas in the one or more zones 318, 320 and 322 with the forecasted traffic congestion level, forecasted number of vehicles in the areas in the one or more zones 318, 320 and 322 with the forecasted traffic congestion level, roads having the highest forecasted traffic congestion level present in the one or more zones 318, 320 and 322, highways having the highest forecasted traffic congestion level present in the one or more zones 318, 320 and 322 or the like.

In an embodiment of the present invention, the operator 118, via using the user device 120, can annotate the regions on the one or more zones 318, 320 and 322 with the visually overlaid forecasted traffic congestion level. The operator 118, via using the user device 120, can annotate the visually overlaid map using the user controls 126 as described in FIG. 1 of the present invention. The user device 120 of the operator 118 is programmed to allow the operator 118 to share the annotated map to other operators using the user controls 126. This approach helps in giving ample time to the operator 118 to manage the traffic well in advance.

In an embodiment, the user device 120 of the operator 118 stores the annotated map as a separate version in the memory of the user device 120. The different versions (ongoing as well as old versions) of the annotated map reflects the modifications performed in the map with visually overlaid forecasted traffic levels over a period of time. The different versions can be downloaded separately or can be accessed by the authorized operators.

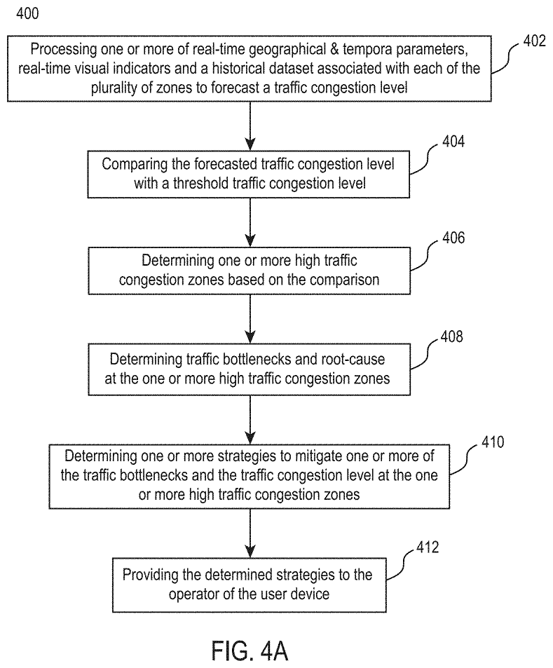

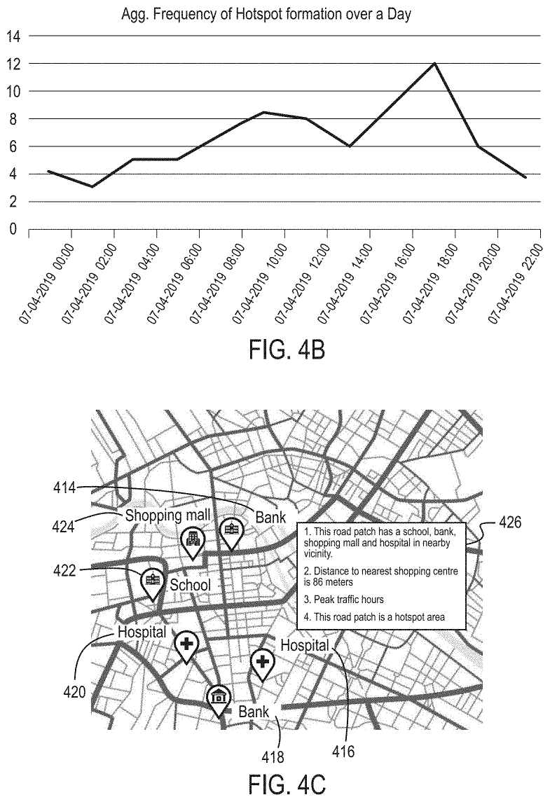

In an embodiment of the present invention, the traffic congestion forecasting system 116 is also configured to determine one or more traffic bottlenecks and root cause analysis thereof present in the one or more zones 104. The detailed process is illustrated in FIG. 4A of the present invention.

FIG. 4A is a flowchart 400 illustrating an exemplary workflow for congestion bottleneck and root cause analysis thereof by the traffic congestion forecasting system, according to an embodiment of the present invention. The process begins at step 402, wherein the one or more of real-time geographical & temporal parameters, real-time visual indicators and a historical dataset associated with each of the plurality of zones 104 to forecast a traffic congestion level associated with the one or more zones 104 as described in FIG. 3A of the present invention.

At step 404, the traffic forecasting module 210 compares the forecasted traffic congestion level associated with the one or more zones 104 with a threshold congestion level. The one or more of real-time geographical & temporal parameters, real-time visual indicators and a historical dataset associated with the one or more of the plurality of zones 104 is analyzed by the traffic forecasting module 210 to determine different congestion levels associated with the one or more of the plurality of zones 104. The traffic forecasting module 210 is suitably programmed to determine the threshold congestion level associated with the one or more zones 104 by analyzing the historical data associated with the one or more zones 104. In an embodiment of the present invention, the traffic forecasting module 210 is configured to rate the congestion level associated with the one or more of the plurality of zones 104 on a scale of 1-10 and assign confidence ratings of the congestion level associated with the one or more of the plurality of zones 104. The traffic forecasting module 210 may assign confidence ratings to the forecasted traffic congestion levels associated with the one or more of the plurality of zones 104 having the forecasted congestion level above the scale of 5. The one or more zones 104 with the assigned having the traffic congestion levels above the scale of 5 may be considered as the threshold value by the traffic forecasting module 210. In another embodiment of the present invention, the confidence rating threshold may vary depending on the one or more of real-time geographical & temporal parameters, real-time visual indicators and a historical dataset associated with the one or more of the plurality of zones 104. In another embodiment of the present invention, the traffic forecasting module 210 may receive the threshold congestion level associated with the one or more zones 104 from the operator 118, via the user device 120.

At step 406, the one or more zones 104 having forecasted congestion level above the threshold congestion level may be determined as one or more high congestion zones 104 by the traffic forecasting module 210. The one or more high congestion zones 104 determined by the traffic forecasting module 210 may indicate the one or more zones 104 which require immediate attention of the operator 118 as they can impose a great threat on the traffic management. In an embodiment of the present invention, the one or more high congestion zones 104 may be generated by the traffic forecasting module 210 for different time intervals such as not limited to minutes, hour, month, yearly intervals. The one or more high congestion zones 104 generated by the traffic forecasting module 210 includes details such as, but not limited to, name of the one or more high congested zones 104, location of the one or more high congested zones 104, start time of the one or more high congested zones 104, end time of the one or more high congested zones 104 or the like.

At step 408, the traffic forecasting module 210 transmits the information related to the one or more high congestion zones 104 to the congestion bottleneck identification module 212 wherein the information related to the one or more high congestion zones 104 includes one or more real-time geographical & temporal parameters, real-time visual indicators and a historical dataset associated with the one or more high congestion zones 104. The congestion bottleneck identification module 212 statistically analyzes the past bottleneck associated with the one or more high congestion zones 104 to determine a pattern of the one or more high congestion zones 104 where one or more bottlenecks were identified in the past. In addition to this, the congestion bottleneck identification module 212 also analyses the start and the end time of the bottleneck identified. For example, the one or more high congestion zones 104 may include a school, a flyover having high elevation, a petrol pump and an administrative building along the one or more high congestion zones 104 which have served as the bottleneck in the past. The congestion bottleneck identification module 212 analyzes different parameters such as starting and ending time of the school, the petrol pump, the administrative building derived from the historical dataset, peak hours of the school derived from the petrol pump, the administrative building, the obstacles near the school, the petrol pump, the administrative building which have contributed to the formation of the bottleneck in the past. The past slope and elevation data of the flyover may be analyzed to determine a pattern of the time and the days when the flyover was identified as the bottleneck based on the analysis of the historical dataset.

After the congestion bottleneck identification module 212 derives a pattern of the past bottleneck identified in the one or more high congestion zones 104. The congestion bottleneck identification module 212 analyses the one or more real-time geographical & temporal parameters, real-time visual indicators associated with the one or more high congestion zones 104. The one or more real-time geographical & temporal parameters, real-time visual indicators may indicate the real-time parameters such as weather, latitude/longitude details of the places with steady movement of the traffic, elevation information of the one or more high congestion zones 104, road obstacles indicated by the visual feed, road accident indicated by the visual feed. The analysis of the one or more real-time geographical & temporal parameters, real-time visual indicators associated with the one or more high congestion zones 104 results in the formation of a pattern for the bottleneck identification. The congestion bottleneck identification module 212 combines the patterns derived from the analysis if the historical dataset associated with the one or more high congestion zones 104, the one or more real-time geographical & temporal parameters, real-time visual indicators associated with the one or more high congestion zones 104 to generate the pattern of bottleneck identified. The combined pattern of the bottleneck identified by the congestion bottleneck identification module 212 is highly accurate as it based on the analysis of both real-time and the historical dataset associated with the one or more high congested zones 104. In an embodiment of the present invention, the bottleneck patterns can be identified by the congestion bottleneck identification module 212 independently based on one or more real-time geographical & temporal parameters, real-time visual indicators, historical dataset associated with the one or more high congested zones 104 without the reliance on each other.

At step 408, the determined bottleneck associated with the one or more high congestion zones 104 identified by the congestion bottleneck identification module 212 is transmitted to the root cause analysis module 214 along with the one or more real-time geographical & temporal parameters, real-time visual indicators, historical dataset associated with the one or more high congested zones 104 is transmitted to the root cause analysis module 214. The root cause analysis module 214 analyses the historical dataset associated with the one or more high congested zones 104 to identify the historical dataset associated with the bottlenecks identified. The root cause analysis module 214 identifies the root cause associated with the bottleneck in the past and their effect on the bottleneck in the past, the past data also provides a trend analysis associated with the bottleneck identifies wherein the trend analysis represents the reasons which were most responsible for the formation of the bottleneck in the past such as, but not limited to, accidents, flood, road elevation, constructional activities, public gathering event, obstacles present on the road. Such historical dataset helps in identifying a pattern of reasons responsible for the formation of the bottleneck in the past. The root cause analysis module 214 also analysis the one or more real-time geographical & temporal parameters, real-time visual indicators associated with the one or more bottleneck identified to identify the root causes for the identified bottleneck. For example, the one or more real-time geographical & temporal parameters may indicate that due to high road elevation the traffic movement has reduced at the bottleneck identified, due to the peak hours of the day the traffic is getting accumulated at the bottleneck identified. The one or more visual indicators associated with the bottleneck may indicate an accident event at the bottleneck identified which has resulted in a traffic congestion. The root cause analysis module 214 analyzes these parameters to identify the root cause pattern identified by the statistical analysis of the one or more real-time geographical & temporal parameters, real-time visual indicators. The pattern identified by the root cause analysis module 214 by the analysis of the historical dataset and the one or more real-time geographical & temporal parameters, real-time visual indicators is combined to generate the root cause analysis associated with the bottleneck identified in the one or more high congestion zones 104. The root cause analysis may include parameters such as details of the root cause such as latitude/longitudinal details, place, time, date, distance to nearby places or the like.

In an embodiment of the present invention, the root cause analysis may be used to predict long term traffic forecasts associated with the one or more high congestion zones 104. For example, in case the operator 118 is in charge of approving the constructional activities at the one or high congestion zones 104. The operator 118, via using the user device 120, can use the root cause analysis associated with the bottlenecks identified in the one or more high congestion zones 104 to plan the construction project in advance while ensuring the smooth flow of the traffic at the same time.

At step 410, the bottleneck identified along with the root cause analysis thereof is transmitted by the root cause analysis module 214 to the recommendation module 218 of the traffic congestion forecasting system 116 along with the one or more real-time geographical & temporal parameters, real-time visual indicators and the historical dataset associated with the one or more high traffic congestion zones 104. The recommendation module 218 analyses the root cause analysis associated with the bottleneck identifies to search for similar root cause analysis in the historical dataset associated with the bottleneck identified. The recommendation module 218 may analyze the one or more past determined strategies and their effect on the traffic congestion level and the bottleneck identified in the one or more high congestion zones 104. The recommendation module 218 processes the one or more determined strategies from the historical dataset to validate the one or more determined strategies corresponding to the one or more real-time geographical & temporal parameters, real-time visual indicators associated with the one or more high congestion zones 104. The one or more strategies which are determined to be the most efficient to mitigate one or more of the traffic bottlenecks and the traffic congestion level at the one or more high traffic congestion zones 104 are provided as output by the recommendation module 218. The one or more determined strategies to mitigate one or more of the traffic bottlenecks and the traffic congestion level at the one or more high traffic congestion zones 104 can include a traffic light simulation pattern or a divergence route simulation.

At step 412, the one or more determined strategies to mitigate one or more of the traffic bottlenecks and the traffic congestion level at the one or more high traffic congestion zones 104 are provided to the operator 118 in the form of an alert by the recommendation module 218. The alert can be provided to the user device 120 of the operator 118. The recommendation module 218 is suitably configured to transmit the one or more determined strategies to mitigate one or more of the traffic bottlenecks and the traffic congestion level at the one or more high traffic congestion zones 104 are as a visual simulation. The visual simulation shows the implementation of the one or more determined strategies to mitigate one or more of the traffic bottlenecks and the traffic congestion level at the one or more high traffic congestion zones 104 in real-time. The real-time implementation of the one or more strategies helps the operator 118 to be completely ensure of the effects of the execution of the one or more determined strategies to mitigate one or more of the traffic bottlenecks and the traffic congestion level at the one or more high traffic congestion zones 104.

In an embodiment of the present invention, the user device 120 of the operator 118 is programmed to provide the operator 118 via the user interface of the user device 120 with an option to accept or reject the one or more determined strategies to mitigate one or more of the traffic bottlenecks and the traffic congestion level at the one or more high traffic congestion zones 104. The user device 120 of operator 118 can also be programmed to allow the operator 118 to generate one or more visually simulated strategies to mitigate one or more of the traffic bottlenecks and the traffic congestion level at the one or more high traffic congestion zones 104 by using the stimulation interface 128 of the user device 120. The user device 120 of the operator allows the operator 118 to generate one or more visually simulated strategies based on the forecasted traffic congestion level, bottleneck identification and root cause analysis thereof.

FIG. 4B illustrates an exemplary historical bottleneck identification trend over a time period, according to an embodiment of the present invention. The bar graph illustrates the average frequency of one or more bottleneck identified over a time period. In this embodiment of the present invention, the graph shows the frequency of one or more bottleneck identified over a day. However, the graph can be generated for any given time period such as, but not limited to, an hour, a minute, a week, a month, a year or the like. In some examples, the time period for which the graph is to be generated may include a date range where the operator 118, via using the user device 120, provides a start date and an end date. The operator 118, via using the user device 120, can generate such graphs using the user controls 126 as described in FIG. 1 of the present invention. In an embodiment of the present invention, the graph can be generated by the user device 120 of the operator 118 for the forecasted traffic congestion level, congestion bottleneck identification and root cause analysis thereof. In another embodiment of the present invention, the user device 120 of the operator 118 is suitably programmed to generate the forecasted traffic congestion level, congestion bottleneck identification and root cause analysis thereof in the form of a vein diagram, a pie chart, a bubble chart, or the like. In another embodiment of the present invention, the graph can be generated by the user device 120 of the operator 118 for one or more zones 104 as selected by the operator 118.

The graph generated by the user device 120 of the operator 118 based on the forecasted traffic congestion level, congestion bottleneck identification and root cause analysis thereof determined by the traffic congestion forecasting system 116 illustrates the bottleneck identification trend over a day at different time intervals. For example, as depicted by the graph the bottleneck identified in the one or more zones 104 at 2 PM were relatively less, but as the traffic level increased, at time 6 PM, the number of bottleneck identified started increasing. The number of bottlenecks identified increased exponentially till 10 PM and then dropped at 2 AM. The bottleneck identified by the traffic congestion forecasting system 116 experienced a soaring increase till 6 AM and after 6 PM the number of bottlenecks decreased significantly. Such pattern identified by the traffic congestion forecasting system 116 helps the operator 118 to analyze the historical bottleneck pattern to manage the traffic accordingly in real-time. In one embodiment of the present invention, the traffic congestion forecasting system 116 is suitably programmed to generate such graphs automatically for the forecasted traffic congestion level, congestion bottleneck identification and root cause analysis thereof.

The detailed analysis of the bottleneck identified in the past helps to identify effective one or more strategies to mitigate the forecasted traffic congestion level and the congestion bottleneck identification and their root cause analysis thereof by the traffic congestion forecasting system 116 and/or the operator 118.

In an embodiment of the present invention, such analysis can be generated by the traffic congestion forecasting system 116 and/or the operator 118, via using the user device 120, for one or more of real-time geographical & temporal parameters, real-time visual indicators associated and historical dataset associated with each of the plurality of zones 104.

FIG. 4C illustrates an exemplary diagram showing visually overlaid bottleneck and root cause analysis thereof associated with the one or more zones 104 generated by the traffic congestion forecasting system 116, according to an embodiment of the present invention. The diagram shows one or more congestion bottleneck identified i.e. 414, 416, 418, 420, 422, and 424 along with their root causes associated with the one or more zones 104 selected by the operator 118, via using the user device 120, as discussed in step 408 of the present invention. In an exemplary embodiment of the present invention, the one or more congestion bottleneck identified 414, 416, 418, 420, 422, 424 by the traffic congestion forecasting system 116 is a hospital, a petrol station, a school, an administrative building and a shopping mall respectively. The user device 120 can provide the option to the operator 118 to click on the visually overlaid bottleneck to access the details 426 of the congestion bottleneck identified by the traffic congestion forecasting system 116. The details 426 can include parameters such as, but not limited to, latitude/longitudinal details of the congestion bottleneck, distance of the other bottlenecks identified from the location of the bottleneck, root cause analysis of the congestion around the bottleneck, forecasted traffic flow around the bottleneck, forecasted speed of vehicles around the bottleneck, road elevation data associated with the bottleneck, peak hours of congestion around the bottleneck, one or more real-time geographical & temporal parameters, real-time visual indicators and historical dataset responsible for the formation of the bottleneck in the past and real-time. The user device 120 is programmed to provide the operator 118 the ability to access the congestion bottleneck identified and the root cause analysis to control the traffic in advance thereby reducing the traffic congestion around the congestion bottleneck identified.

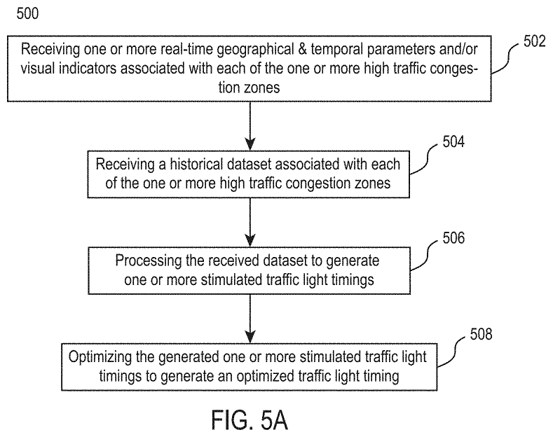

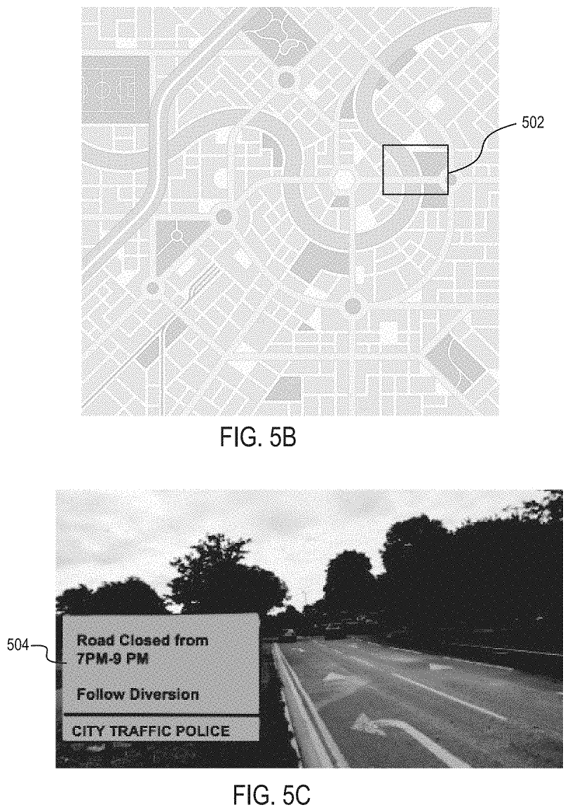

As discussed in FIG. 4A of the present invention that the one or more strategies to mitigate the traffic bottlenecks and the traffic congestion level at the one or more high traffic congestion zones 104 comprises at least one of a traffic light timing simulation and a divergence route simulation. FIG. 5A illustrates an exemplary workflow 500 to optimize the timings of a traffic light by the recommendation module 218, according to an embodiment of the present invention. At step 502, the recommendation module 218 of the traffic congestion forecasting system 116 is configured to receive one or more real-time geographical & temporal parameters and/or visual indicators associated with each of the one or more high traffic congestion zones 104 from the first input source 106 and the second input source 108 via the communication network 112. The recommendation module 218 processes the one or more real-time geographical & temporal parameters and/or visual indicators associated with each of the one or more high traffic congestion zones 104 to fetch the traffic flow information wherein the traffic flow information can include parameters such as, but not limited to, number of vehicles on the road, speed of the vehicles, distance of the vehicles from the one or more high traffic congestion zones 104 or the like. The traffic flow information helps the recommendation module 218 to estimate the timings of the traffic lights with reduced wait time. At step 504, the recommendation module 218 of the traffic congestion forecasting system 116 is configured to receive a historical dataset associated with each of the one or more high traffic congestion zones 104 from the database 114 via the communication network 112 or the memory 204. The recommendation module 218 analyses the one or more past determined strategies and their effect on the traffic congestion level and the bottleneck identified in the one or more high congestion zones 104. At step 506 the recommendation module 218 processes the one or more determined strategies from the historical dataset to validate the one or more determined strategies corresponding to the fetched traffic flow information from the one or more real-time geographical & temporal parameters and/or visual indicators associated with each of the one or more high traffic congestion zones 104. The validation is performed by the recommendation module 218 to check if the past one or more determined strategies will work efficiently in correspondence to the real time traffic flow information. If the validation results in a positive response, the recommendation module 218 generates the past implemented one or more traffic light timings to mitigate one or more of the traffic bottlenecks and the traffic congestion level at the one or more high traffic congestion zones 104 as an output. In alternate scenario, if the validation results in a negative response, the recommendation module 218 generates a new set of one or more traffic light timings to mitigate one or more of the traffic bottlenecks and the traffic congestion level at the one or more high traffic congestion zones 104.

At step 508, the generated one or more traffic light timings by the recommendation module 218 is configured to stimulate the one or more of the traffic light timings to mitigate the traffic bottlenecks and the traffic congestion level at the one or more high traffic congestion zones 104 on a map. The generated one or more traffic light timings to mitigate one or more of the traffic bottlenecks and the traffic congestion level at the one or more high traffic congestion zones 104 are further optimized by the recommendation module 218 to generate an optimized traffic light timing. The generated one or more traffic light timings are simulated the recommendation module 218 on the map to calculate the average waiting time according to each of the one or more generated traffic light timings. The traffic light timing which is determined the recommendation module 218 to have the lowest average waiting time is provided to the operator 118 as the optimized traffic light timing by the recommendation module 218. This approach helps in forecasting the best suitable timing by the recommendation module 218 to mitigate one or more of the traffic bottlenecks and the traffic congestion level at the one or more high traffic congestion zones 104.

In an embodiment of the present invention, the user device 120 of the operator 118 can provided an option to the operator 118 to accept or reject the optimized light timing generated by the recommendation module 218. In another embodiment of the present invention, the user device 120 of the operator 118 can provide the user interface to the operator 118 to enter the timings to generate a visually stimulated traffic light timing to mitigate one or more of the traffic bottlenecks and the traffic congestion level at the one or more high traffic congestion zones 104 by using the simulation interface 128 as discussed in FIG. 1 of the present invention.

FIG. 5B and 5C illustrates an exemplary diagram illustrating a simulated traffic light simulation and a divergence route simulation respectively, according to an embodiment of the present invention.

FIG. 5B illustrates the simulated traffic light timing as generated by the workflow 500. The simulated traffic light timing generated by the recommendation module 218 includes the optimized traffic light timing 502. The optimized timing 502 generated by the recommendation module 218 can be executed in real-time that helps the operator 118 of the user device 120 to manage the traffic flow effectively. FIG. 5C illustrates the divergence route simulation 504 to manage the traffic in advance by the operator 118. The operator 118 can either place the divergence board on the road of the one or more high congestion zones 104. In another embodiment of the present invention, the user device 120 of the operator 118 facilitates the operator 118 to share the divergence route simulation 504 with the other operators by using the user controls 126 as discussed in FIG. 1 of the present invention. The divergence route simulation 504 helps the operator 118, via using the user device 120, to plan the flow of the traffic in advance, which reduces the chances of the traffic congestion and ensures a smooth flow of the traffic.

In embodiment of the present invention, the divergence route simulation 504 can be generated by the recommendation module 218 based on the analysis of the one or more real-time geographical & temporal parameters and/or visual indicators, historical dataset associated with each of the one or more high traffic congestion zones 104. The divergence route simulation 504 can be generated by the recommendation module 218 for both short term and long term traffic predictions.

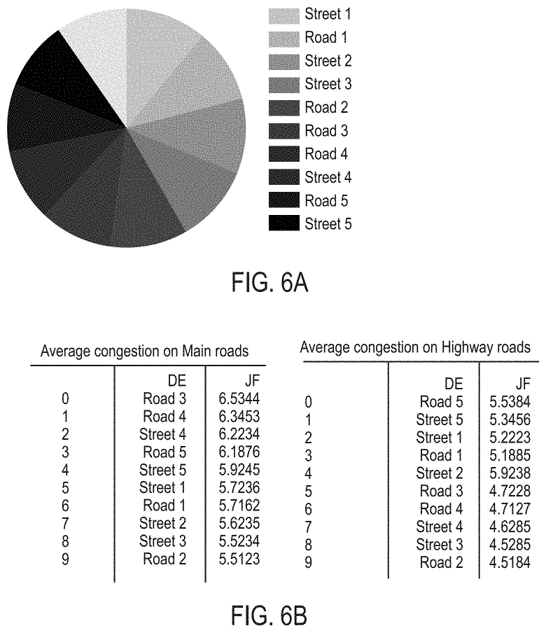

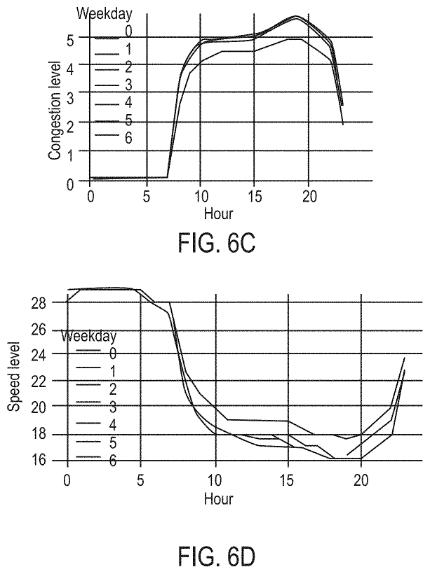

FIG. 6A, 6B, 6C and 6D illustrates exemplary statistical analysis associated with the traffic bottlenecks and the traffic congestion level associated with the plurality of zones 104, according to an embodiment of the present invention. The statistical analysis can be generated for each of the plurality of the zones 104, one of the each of the plurality of the zones 104, sub-section of one of the each of the plurality of the zones 104 such as, a highway, a flyover, a particular road, a patch located in the each of the plurality of the zones 104 or the like by the traffic congestion forecasting system 116. The operator 118, via using the user device 120, can specify the location of the one or more of the plurality of the zones 104 for which the statistical analysis is to be generated.

FIG. 6A illustrates the top 10 congested roads in the one or more zones 104 selected by the operator 118, via using the user device 120, according to an embodiment of the present invention . The statistical analysis of the top 10 congested roads can include statistical measurements such as, but not limited to, traffic density, latitude/longitudinal details, peak hours, start and end time of the congestion, bottleneck along with their root cause analysis, the one or more strategies to mitigate the traffic congestion and bottleneck, optimized traffic light timing, divergence route simulation, estimated speed or the like. In an embodiment, of the present invention, different quantitative statistical analysis can be provided to different user devices 120 of the operators 118 based on their designation. For example, if the operator 118 is a civilian or a driver, they may not be provided with the information by the traffic congestion forecasting system 116 on the user device 120 such as, but not limited to, the one or more strategies to mitigate the traffic congestion and bottleneck, optimized traffic light timing. The operator 118, via using the user device 120, can specify the duration for which the statistical analysis is to be generated wherein the duration can include an hourly, daily, weekly, or monthly time duration. In some examples, the time duration may include a date range where the operator 118, via using the user device 120, provides a start date and an end date.

FIG. 6B illustrates the average congestion level on the main and highway roads of the one or more zones 104 selected by the operator according to an embodiment of the present invention. The average congestion level can be rated on a scale of 0-10 by the traffic congestion forecasting system 116. The average congestion level can also include the latitude/longitudinal details of the road along with the junction details where the road connects. In another embodiment of the present invention, if the operator 118 of the user device 120 is a driver of a vehicle, the average congestion level can help the operator 118 of the user device 120 to avoid the roads with high average congestion levels. In another embodiment of the present invention, if the operator 118 of the user device 120 is a traffic official, the average congestion level can help the operator 118 of the user device 120 to manage the traffic congestion efficiently. The operator 118 of the user device 120 can specify the duration for which the average congestion level is to be generated by using the user interface of the user device 120 wherein the duration can include an hourly, daily, weekly, or monthly time duration. In some examples, the time duration may include a date range where the operator 118, via using the user device 120, provides a start date and an end date.

FIG. 6C and 6D illustrates the graph with the forecasted congestion and speed level associated with the one or more zones 104, according to an embodiment of the present invention. The forecasted congestion and speed level helps the operator 118 of the user device 120 to manage the speed in advance to avoid traffic congestion. For example, the user device 120 of the operator 118 may be configured to provide the operator 118 with a speed level forecast based on the congestion level. The adherence to the forecasted speed levels can help the operator 118 of the user device 120 to mitigate the congested roads. The operator 118, via using the user device 120, can specify the duration for which the forecasted congestion and speed level is to be generated wherein the duration can include an hourly, daily, weekly, or monthly time duration. In some examples, the time duration may include a date range where the operator 118, via using the user device 120, provides a start date and an end date.

According to an embodiment of the present invention, the traffic congestion forecasting system 116 is suitably configured to generated the statistical analysis in the form of a vein diagram, a pie chart, a bubble chart, or the like.

According to another embodiment of the present invention, for the civilian or the driver operator 118, the statistical information can be integrated into the service application installed in the user device 120 of the operator 118. The statistical information can be provided by the traffic congestion forecasting system 116 in the form of an alert to the operator 118.

It is to be noted herein that various aspects and objects of the present invention described above as methods and processes should be understood to an ordinary skilled in the art as being implemented using a system that includes a computer that has a CPU, display, memory and input devices such as a keyboard and mouse. According to an embodiment, the system is implemented as computer readable and executable instructions stored on a computer readable media for execution by a general or special purpose processor. The system may also include associated hardware and/or software components to carry out the above described method functions. The system is preferably connected to an internet connection to receive and transmit data.

Although illustrated as discrete components, various components may be divided into additional components, combined into fewer components, or eliminated while being contemplated within the scope of the disclosed subject matter. It will be understood by those skilled in the art that each function and/or operation of the components may be implemented, individually and/or collectively, by a wide range of hardware, software, firmware, or virtually any combination thereof. The system components may be provided by one or more server computers and associated components.

The term “computer-readable media” as used herein refers to any medium that provides or participates in providing instructions to the processor of the computer (or any other processor of a device described herein) for execution. Such a medium may take many forms, including but not limited to, non-volatile media and volatile media. Non-volatile media include, for example, optical, magnetic, or opto-magnetic disks, such as memory. Volatile media include dynamic random access memory (DRAM), which typically constitutes the main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM or EEPROM (electronically erasable programmable read-only memory), a FLASH-EEPROM, any other memory chip or cartridge, or any other medium from which a computer can read.

Although the present invention has been described in terms of certain preferred embodiments, various features of separate embodiments can be combined to form additional embodiments not expressly described. Moreover, other embodiments apparent to those of ordinary skill in the art after reading this disclosure are also within the scope of this invention. Furthermore, not all of the features, aspects and advantages are necessarily required to practice the present invention. Thus, while the above detailed description has shown, described, and pointed out novel features of the invention as applied to various embodiments, it will be understood that various omissions, substitutions, and changes in the form and details of the apparatus or process illustrated may be made by those of ordinary skill in the technology without departing from the spirit of the invention. The inventions may be embodied in other specific forms not explicitly described herein. The embodiments described above are to be considered in all respects as illustrative only and not restrictive in any manner. Thus, scope of the invention is indicated by the following claims rather than by the above description.

What is claimed is:

1. A computer-implemented method, for implementation by a traffic congestion forecasting system, for congestion bottleneck identification and root cause analysis thereof, the computer-implemented method comprising:
receiving one or more of real-time geographical & temporal parameters, real-time visual indicators associated with each of a plurality of zones;
receiving a historical dataset associated with each of the plurality of zones, wherein the historical dataset comprises one or more of past geographical & temporal parameters and effects thereof on past traffic congestion level, past visual indicators and effects thereof on past traffic congestion level, past bottleneck and past traffic congestion levels with associated root-cause thereof;
forecasting traffic congestion level at one or more of the plurality of zones by processing one or more of the received real-time geographical parameters, the real-time visual indicators, and the historical dataset associated thereof;
visually overlaying the forecasted traffic congestion level at the one or more zones on a map; and
facilitating display of the map on one or more user devices with overlaid traffic congestion level.

2. The computer implemented method of claim 1, wherein the one or more real-time geographical & temporal parameters is received from a Geographic Information System (GIS) and the one or more real-time visual indicators is received from a video source.

3. The computer-implemented method of claim 1, wherein the geographical & temporal parameters comprises one or more of weather conditions, a real-time and historical geographic traffic pattern, a road elevation information, traffic information received from GPS devices in proximity of the zones, latitude/ longitude details of the zones, road width, a news forecast of the zones, a real-time geographic travel pattern, traffic congestion duration at the zones, potential traffic hotspots and location thereof, information related to potential traffic obstruction points in vicinity of the zones, and peak time associated with traffic obstruction hotspots.

4. The computer-implemented method of claim 1, wherein the visual indicators comprises one or more of a visual data-feed captured by cameras installed in vicinity of at least one of the plurality of zones, data feeds from traffic light cameras, visual feeds from dashcams, visual feeds indicating traffic movement, visual feed indicating pedestrian movement, visual feed indicating road obstacles, visual feed received one or more video sensors, visual feed indicating people density in an geographical area, visual feeds indicating road accident, visual feeds indicating construction, and visual feeds indicating congestion density.

5. The computer-implemented method of claim 1, wherein said forecasting the traffic congestion level at one or more of the plurality of zones further comprises:
receiving location of the one or more zones from an operator of the user device for which the traffic congestion level is to be forecasted.

6. The computer-implemented method of claim 1, wherein said method further comprises:
receiving a desired time frame selected by an operator of the user device for which the traffic is to be forecasted; and
forecasting the traffic congestion level at one or more of the plurality of zones for the desired time frame.

7. The computer-implemented method of claim 1, wherein said forecasting the traffic congestion level at the one or more of the plurality of zones further comprises:
determining one or more high traffic congestion zones by comparing the forecasted traffic congestion level with a threshold traffic congestion level;
determining traffic bottlenecks and root-cause thereof at the one or more high traffic congestion zones by analyzing the one or more of the received real-time geographical & temporal parameters, the real-time visual indicators, and the historical dataset associated with the one or more high traffic congestion zones;
determining one or more strategies to mitigate one or more of the traffic bottlenecks and the traffic congestion level at the one or more high traffic congestion zones; and
providing the determined strategies to an operator of the user device.

8. The computer-implemented method of claim 7, wherein said determining one or more strategies to mitigate one or more of the traffic bottlenecks and the traffic congestion level further comprises:
generating one or more simulated strategies to mitigate one or more of the traffic bottlenecks and the traffic congestion level, wherein the simulated strategies comprises at least one of a traffic light timing simulation and a divergence route simulation.

9. The computer-implemented method of claim 1, wherein said forecasting the traffic congestion level comprises forecasting the traffic congestion level by using a feedforward neural network.

10. The computer-implemented method of claim 9, wherein said feedforward neural network comprises a ReLu activation and/or a Nesterov ADAM optimizer to generate the forecasted traffic congestion level.

11. A system for congestion bottleneck identification and root cause analysis thereof, said system comprising:
at least one processor; and
a memory that is coupled to the at least one processor and that includes computer-executable instructions, wherein the at least one processor, based on execution of the computer-executable instructions, is configured to:
receive one or more real-time geographical & temporal parameters associated with each of a plurality of zones from a first input source;
receive one or more real-time visual indicators associated with each of the plurality of zones from a second input source;
receive a historical dataset associated with each of the plurality of zones, wherein the historical dataset comprises one or more of past geographical & temporal parameters and effects thereof on past traffic congestion level, past visual indicators and effects thereof on past traffic congestion level, past bottleneck and past traffic congestion levels with associated root-cause thereof;
forecast traffic congestion level at one or more of the plurality of zones by processing one or more of the received real-time geographical & temporal parameters, the real-time visual indicators, and the historical dataset associated thereof;
present a visualization depicting the forecasted traffic congestion level at the one or more zones on a map; and
facilitate a display of the map on one or more user devices with overlaid traffic congestion level.

12. The system of claim 11, wherein the first input source is a Geographic Information System (GIS) and the second input source is a video source.

13. The system of claim 11, wherein the geographical & temporal parameters comprises one or more of weather conditions, a real-time and historical geographic traffic pattern, a road elevation information, traffic information received from GPS devices in proximity of the zones, latitude/ longitude details of the zones, road width, a news forecast of the zones, a real-time geographic travel pattern, traffic congestion duration at the zones, potential traffic hotspots and location thereof, information related to potential traffic obstruction points in vicinity of the zones, and peak time associated with traffic obstruction hotspots.

14. The system of claim 11, wherein the visual indicators comprises one or more of a visual data-feed captured by cameras installed in vicinity of at least one of the plurality of zones, data feeds from traffic light cameras, visual feeds from dashcams, visual feeds indicating traffic movement, visual feed indicating pedestrian movement, visual feed indicating road obstacles, visual feed received one or more video sensors, visual feed indicating people density in an geographical area, visual feeds indicating road accident, visual feeds indicating construction, and visual feeds indicating congestion density.

15. The system of claim 11, wherein the at least one processor being configured to forecast the traffic congestion level at one or more of the plurality of zones is further configured to:
receive location of the one or more zones from an operator of the user device for which the traffic congestion level is to be forecasted.

16. The system of claim 11, wherein the at least one processor being configured to forecast the traffic congestion level at one or more of the plurality of zones is further configured to:
receive a desired time frame selected by an operator of the user device for which the traffic is to be forecasted; and
forecast the traffic congestion level at one or more of the plurality of zones for the desired time frame.

17. The system of claim 11, wherein the at least one processor being configured to forecast the traffic congestion level at one or more of the plurality of zones is further configured to:
determine one or more high traffic congestion zones by comparing the forecasted traffic congestion level with a threshold traffic congestion level;
determine traffic bottlenecks and root-cause thereof at the one or more high traffic congestion zones by analyzing the one or more of the received real-time geographical & temporal parameters, the real-time visual indicators, and the historical dataset associated with the one or more high traffic congestion zones;
determine one or more strategies to mitigate one or more of the traffic bottlenecks and the traffic congestion level at the one or more high traffic congestion zones; and
provide the determined strategies to an operator of the user device.

18. The system of claim 17, wherein the at least one processor being configured to determine one or more strategies to mitigate one or more of the traffic bottlenecks and the traffic congestion level is further configured to:
generate one or more simulated strategies to mitigate one or more of the traffic bottlenecks and the traffic congestion level, wherein the simulated strategies comprises at least one of a traffic light timing simulation and a divergence route simulation.

19. The system of claim 11, wherein the at least one processor being configured to forecast the traffic congestion level is configured to forecast the traffic congestion level by using a feedforward neural network.

20. The system of claim 19, wherein said feedforward neural network comprises a ReLu activation and/or a Nesterov ADAM optimizer to generate the determined traffic congestion level.

21. A computer-readable medium comprising computer-executable instructions that, based on execution by at least one processor of a computing device, cause the computing device to perform one or more steps of the method of claim 1.
